(19) United States
(12) Patent Application Publication
(10) Pub. No.: US 2024/0109808 A1
(43) Pub. Date: Apr. 4, 2024

(54) LIVING BUILDING MATERIALS, METHODS OF MANUFACTURE THEREOF AND ARTICLES COMPRISING THE SAME

(71) Applicants: The Regents of the University of Colorado, a body corporate, Denver, CO (US); Prometheus Materials Inc., Longmont, CO (US)

(72) Inventors: Wilfred V. Srubar, III, Boulder, CO (US); Sherri Cook, Boulder, CO (US); Jeffrey Cameron, Erie, CO (US); Mija Hubler, Boulder, CO (US); Stephen Bell, Berthoud, CO (US); Linfei Li, Superior, CO (US)

(21) Appl. No.: 18/468,812

(22) Filed: Sep. 18, 2023

Related U.S. Application Data
(60) Provisional application No. 63/466,040, filed on May 12, 2023.
(60) Provisional application No. 63/407,513, filed on Sep. 16, 2022.

(51) Int. Cl. C04B 12/00; C04B 16/00; C04B 26/02

(52) U.S. Cl. CPC C04B 12/00; C04B 16/00; C04B 26/026; C04B 2103/0001

(57) ABSTRACT

Disclosed herein is a transportable bio-cement comprising a desiccated microorganism package; where the microorganism package comprises one or more microorganisms; a first binder, where the first binder is produced by the microorganism; and where the microorganism has protected itself by a layer of the first binder; where the transportable bio-cement is devoid of moisture. Disclosed herein too is a method of manufacturing a transportable dry composition comprising blending together a microorganism package; a nutrient; and a liquid; activating the microorganism package to produce a first binder; subjecting the microorganism package to desiccation to form a transportable bio-cement; and blending the transportable bio-cement with an aggregate to form a bio-concrete; where the aggregate comprises a substrate, a second binder, and a liquid.

### CROSS REFERENCE TO RELATED APPLICATIONS

This application claims the benefit of an earlier filing date from U.S. Provisional Application Ser. No. 63/466,040 filed May 12, 2023, and Provisional Application Ser. No. 63/407,513 filed Sep. 16, 2022, both of which are incorporated herein by reference.

### STATEMENT OF FEDERAL SUPPORT

This invention was made with government support under grant number HR0011-17-2-0039 awarded by the U.S. Department of Defense. The government has certain rights in the invention.

### BACKGROUND

This disclosure relates to living building materials, methods of manufacture thereof and articles comprising the same. More specifically, this disclosure relates to biopolymeric and biologically active mortars suitable for use in providing building materials having enhanced physical properties. Further disclosed are methods for making and using the disclosed materials.

Concrete is the most used construction material due to its resistance, durability and low cost in comparison to other construction materials. Annually, more than 10 billion tons of concrete are used at a global level and experts have predicted that the concrete demand is likely to grow to 16 billion tons in 2050. The current technology employed by the construction industry generates a negative impact on the global environment and economy. The industrial process involved in cement production from limestone (precursor of concrete), consumes between 2 and 3% of the global energy demand, generating 0.73-0.99 tons of CO₂/ton of cement produced, which accounts for about 8-10% of the global anthropogenic emissions of CO₂ and 3.4% of the total CO₂ global emissions.

Increase in consumption of concrete is a consequence of the susceptibility of infrastructure to physical, chemical and biological factors such as temperature variations, exposure to corrosive and radioactive substances, aggressive gases, natural disasters, and microbial activity. These factors cause microcracking, which affects mechanical and durability properties of concrete such as compressive strength, flexural strength and permeability, consequently reducing the useful life of concrete and increasing the cost of the maintenance and repair of infrastructures. Although the global cost of concrete production ranges between 60 dollars/m³ to 75 dollars/m³, the average cost for crack repair is about 130 dollars/m³, which reveals the high cost involved in the maintenance and repair of concrete structures.

It is therefore desirable to develop new forms of concrete that minimize the amount of carbon dioxide emitted into the atmosphere. It is also desirable to produce concrete that is less expensive than that currently produced.

### SUMMARY

Disclosed herein is a transportable bio-cement comprising a desiccated microorganism package; where the microorganism package comprises one or more microorganisms; a first binder, where the first binder is produced by the microorganism; and where the microorganism has protected itself by a layer of the first binder; where the transportable bio-cement is devoid of moisture.

Disclosed herein too is a bio-concrete comprising a desiccated microorganism package; where the microorganism package comprises one or more microorganisms; a first binder, where the first binder is produced by the microorganism; and where the microorganism has protected itself by a layer of the first binder; a substrate; where the substrate is operative to act as a site for bonding with the first binder produced by the microorganism; and a second binder.

Disclosed herein too is a method of manufacturing a transportable dry composition comprising blending together a microorganism package; a nutrient; and a liquid; activating the microorganism package to produce a first binder; subjecting the microorganism package to desiccation to form a transportable bio-cement; and blending the transportable bio-cement with an aggregate to form a bio-concrete; where the aggregate comprises a substrate, a second binder, and a liquid.

### BRIEF DESCRIPTION OF THE FIGURES

FIG. 1 depicts one process of manufacturing the dry composition; and

FIG. 2 is a depiction of the various embodiments of the steps in the FIG. 1;

FIG. 3 is a depiction of several other embodiments of the steps in the FIG. 1; and

FIG. 4 depicts another method of manufacturing the bio-cement.

### DETAILED DESCRIPTION

Disclosed herein is an environmentally friendly dry composition (hereinafter dry composition) that withdraws carbon dioxide from the atmosphere to produce a bio-cement that can be used in a variety of building and construction applications. The dry composition is available as a dry powder and comprises a desiccated microorganism package that can be shipped to a manufacturing site at which additional ingredients (collectively termed an aggregate) such as a substrate (also termed a scaffold), a binder and a liquid medium may be added to produce a bio-concrete that can be used in a construction project (such as a building, a bridge, and the like).

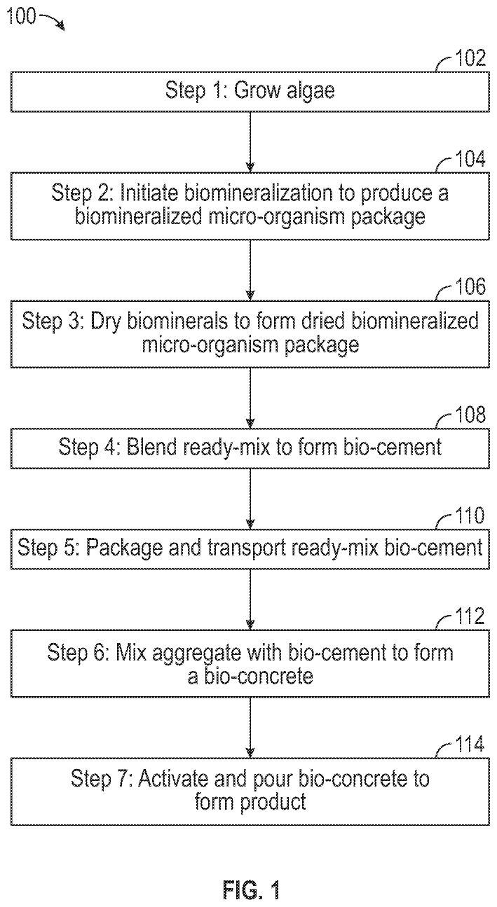

FIG. 1 depicts the process 100 for manufacturing the dry composition and its conversion to the bio-cement which can be molded into a desired shape.

In process 102, the microorganism is first produced by facilitating growth and reproduction of microorganisms in a vat (or a pool) along with a first liquid medium and nutrients. The nutrients are consumed by the microorganisms (along with extracting carbon dioxide, nitrogen and/or sulfur) from the atmosphere to undergo replication and to produce a first binder (this is described in the next process). The nutrients are listed later in this document.

The next process 104 includes bio-mineralization, where the microorganisms produced above in process 102 are provided with a source of minerals such as calcium chloride to produce a first binder. It is to be noted that the process 102 (which involves replication and growth of the microorganisms) may occur simultaneously and/or sequentially with the bio-mineralization process 104. A pH adjusting ingredient (e.g., sodium hydroxide) may be added during the bio-mineralization process. The pH adjusting agent may be added in an amount effective to favor the formation of a carbonate based binder as opposed to a bicarbonate based binder. During this bio-mineralization process 104 the microorganisms extract carbon dioxide, nitrogen and/or sulfur from the atmosphere to produce the first binder.

The bio-mineralized reactant is then subjected to desiccation process 106 (removal of the first liquid medium) and subjected to a first granulation process 108 (also called a ready-mix) to produce a dried biomineralized micro-organism package (also termed a bio-cement) in process 108. During the desiccation process 106, the microorganisms may protect themselves with compounds that promote “desiccation tolerance”. An example of a compound produced during the development of the desiccation tolerance is trehalose. Trehalose may also be added in exogenously to promote desiccation tolerance.

The bio-cement may then be packaged and shipped 110 to a manufacturing site at which additional materials (collectively termed an aggregate) such as an external binder (e.g., (bio)polymers), a substrate (also termed a scaffold) and a second liquid medium may be added to the bio-cement to form a bio-concrete 112. The bio-concrete can be activated in process 114 when the second liquid medium contacts it. In a preferred embodiment, the second liquid medium is an aqueous medium. The external binder serves to bind the biomineralized micro-organism package along with the substrates to produce a bio-concrete. The bio-concrete thus activated may be molded into a product that can be used in a variety of ways. The bio-concrete can be used to produce building blocks such as bricks, cinder blocks, reinforced concrete columns, and the like.

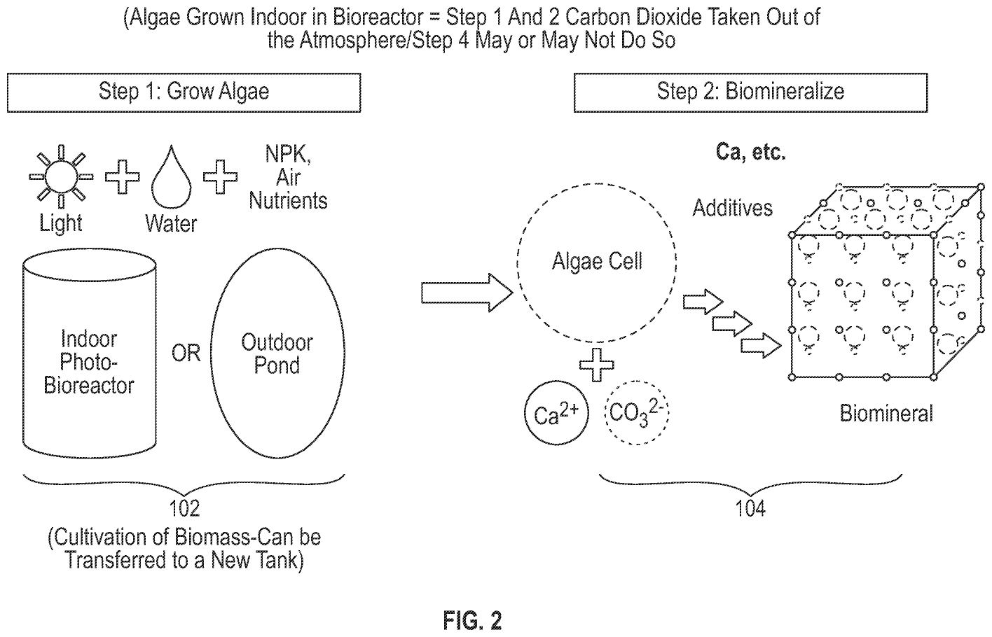

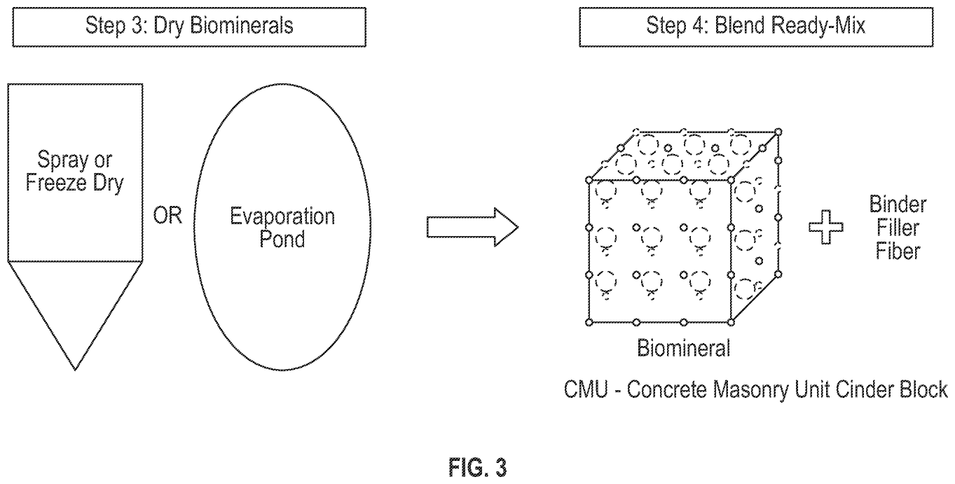

The various processes from the FIG. 1 as well as FIGS. 2 and 3 are detailed below along with the materials used in the particular process.

### Growing Algae 102 and Biomineralization 104

As noted above, in process 102 (See FIGS. 1, 2 and 3) the microorganisms are allowed to replicate and proliferate. They do this by consuming nutrients and a first liquid medium to produce a binder. The microorganisms simultaneously extract a gas from the atmosphere and use this gas to facilitate a reaction with the nutrients to produce the first binder. The microorganisms facilitate production of the first binder.

In an embodiment, a microorganism package may comprise a plurality of different microorganisms that consume nutrients and extract a gas from the atmosphere to produce a first binder that can physically or chemically interact with the eventual substrate (added at the site as part of the aggregate) to bind the substrate particles together. In an embodiment, the microorganism package comprises a first microorganism that uses nutrients and extracts carbon dioxide from the atmosphere to produce a first binder. The microorganism package may optionally comprise a second microorganism that uses nutrients and extracts nitrogen from the atmosphere to produce a second binder. The first and second microorganisms are different from each other.

The microorganism package may optionally comprise a third microorganism that uses nutrients and extracts sulfur from the atmosphere to produce a third binder. The various microorganisms each consume a nutrient and extract a gas from the atmosphere to reproduce and to facilitate the formation of a first binder. The formation of the binder is termed biomineralization. The reproduction (process 102) and the biomineralization (process 104) can take place simultaneously or sequentially. The process 102 where the microorganisms replicate can be conducted in the same or different location from the location where the biomineralization (process 104) is conducted. Biomineralization is the process where the microorganisms are stimulated into producing the binder.

The amount of replication before biomineralization can be measured by culture density (e.g. grams biomass per liter of culture; g/L). It is desirable to get cultures as dense as possible to facilitate the highest yield of biominerals possible in succeeding manufacturing steps. The greater the number of algae cells, the more sites there are available for nucleation/precipitation of CaCO₃.

In an embodiment, the algae growth and biomineralization processes are conducted in separate locations. This is done to prevent fouling of photobioreactors.

The replication step (102) may be conducted for a time period of 1 to 4 weeks. The time for replication is determined by the desired culture density which is ultimately a function of algae growth rate.

The second step (104) involving biomineralization may also be conducted over a period of time of 2 hours to 7 days. The selected time period will be based on yield, quality of product, and turnover time between batches.

When more than one microorganism is present in the microorganism package, the various binders produced by the individual (microorganisms) species may combine to produce a matrix that partially bonds the substrates together to form the bio-cement. The matrix is a combination of the bio-cement and the additional binder (e.g., (bio)polymers) that is added as part of the aggregate. This is detailed later.

In an embodiment, the various binders produced by the respective microorganisms may undergo a reaction with one another and/or react with the nutrients and/or react with the substrate to produce a reaction product (also referred to herein as a precipitate) that becomes a part of the eventual binder.

The binder (which may be a combination of the first binder, the second binder, and the reaction products listed above) serves as a part-matrix (along with the external binder, which is added later) to bond the substrate particles together along with an external binder that is added later after the formation of the bio-cement. This is described in detail later.

The first microorganisms are preferably those that consume carbon dioxide from the atmosphere to produce a carbonate salt that serves as the first precipitate in the binder. The microorganisms may be prokaryotic or eukaryotic, in particular bacteria, yeast, or algae, or a combination thereof. Examples of the microorganisms are Pseudomonadota, Aquificota, Chlamydiota, Bacteroidota, Chlorobiota, Cyanobacteria, Fibrobacterota, Verrucomicrobiota, Planctomycetota, Spirochaetota, Acidobacteriota, Myxococcaceae, Zymomonas, Escherichia, or a combination thereof.

Of the aforementioned microorganisms, cyanobacteria are preferred. Examples of cyanobacteria that may be used in the dry composition include Chroococcales, Chroococcidiopsidales, Gloeobacterales, Nostocales, Oscillatoriales, Pleurocapsales, Spirulinales, Synechococcales, Incertae sedis, Gunflintia, Ozarkcollenia, Cyanothece, Synechocystis, or a combination thereof.

Species of the foregoing microorganisms that may be used in the dry composition include Gloeobacter violaceus PCC 7421, Nostoc sp. PCC 7120, Prochlorococcus marinus MIT 9312, Prochlorococcus marinus MIT 9313, Prochlorococcus marinus NATL2A, Prochlorococcus marinus marinus CCMP 1375, Prochlorococcus marinus pastoris CCMP 1986, Synechococcus elongatus PCC 6301, Synechococcus elongatus PCC 7942, Prochlorococcus sp. CC9311, Prochlorococcus sp. CC9605, Prochlorococcus sp. CC9902, Synechococcus sp. JA-2-3B′a(2-13), Synechococcus sp. JA-3-3Ab, Prochlorococcus sp. WH8102, Synechocystis sp. PCC 6803, Thermosynechococcus elongatus BP-1, Trichodesmium erythraeum IMS101, Prochlorococcus marinus AS9601, Prochlorococcus marinus MIT 9301, Prochlorococcus marinus MIT 9303, Prochlorococcus marinus MIT 9515, Prochlorococcus marinus NATL1A, Synechococcus sp. RCC 307, Prochlorococcus sp. WH 7803, Prochlorococcus marinus MIT 9215, Acaryochloris marina MBIC 11017, Prochlorococcus marinus MIT 9211, Cyanothece sp. BH68, ATCC 51142, Microcystis aeruginosa NIES-843, Synechococcus sp. PCC 7002, Nostoc punctiforme PCC 73102, Cyanothece sp. PCC 7424, Cyanothece sp. PCC 7425, Cyanothece sp. PCC 8801, Cyanothece sp. PCC 8802, Cyanobacterium sp. UCYN-A, Anabaena variabilis ATCC 29413, Nostoc azollae 0708, Cyanothece sp. PCC 7822, Arthrospira platensis NIES-39, Synechocystis sp. GT-S, PCC 6803, Mastigocoleus testarum BC008, Crocosphaera watsonii WH 8501, Cyanobacterium stanieri PCC 7202, Geitlerinema sp. PCC 7407, Chroococcidiopsis thermalis PCC 7203, Halothece sp. PCC 7418, Nostoc sp. PCC 7107, Cyanobacterium aponinum PCC 10605, Gloeocapsa sp. PCC 7428, Stanieria cyanosphaera PCC 7437, Leptolyngbya sp. PCC 7376, Oscillatoria nigro-viridis PCC 7112, Calothrix sp. PCC 6303, Anabaena cylindrica PCC 7122, Pseudanabaena sp. PCC 7367, Crinalium epipsammum PCC 9333, Chroococcidiopsis sp. PCC 6712, Calothrix sp. PCC 7507, Planktothrix NIVA-CYA405, Planktothrix NIVA-CYA406, Planktothrix sp. NIVA-CY A407, Microcoleus vaginates FGP-2, Planktothrix sp. NIVA CYA 15, Planktothrix agardhii NIVA-CYA 34, Planktothrix rubescens NIVA-CYA 98, Anabaena sp. PCC 7108, Spirulina subsalsa PCC 9445, Spirulina major PCC 6313, Synechococcus sp. PCC 7336, Pseudanabaena sp. PCC 6802, Synechococcus sp. KORDI-49 (genome sequencing), Synechococcus sp. KORDI-52 (genome sequencing), Synechococcus sp. KORDI-100 (genome sequencing), Scytonema hofinanni UTEX 2349, Calothrix sp. PCC 7103, Synechococcus sp. WH 8016, Cyanothece sp. BH63E, ATCC 51472, Cyanobium gracile PCC 6307, Synechococcus sp. PCC 7502, Oscillatoria Formosa PCC 6407, Oscillatoria acuminata PCC 6304, Synechococcus sp. PCC 6312, Microcoleus sp. PCC 7113, Prochlorothrix hollandica PCC 9006, Oscillatoria sp. PCC 10802, Dactylococcopsis salina PCC 8305, Pleurocapsa sp. PCC 7327, Pleurocapsa sp. PCC 7319, Cylindrospermum stagnale PCC 7417, Nodosilinea nodulosa PCC 7104, Microchaete sp. PCC 7126, Leptolyngbya boryana PCC 6306, Nostoc sp. PCC 7524, Leptolyngbya sp. PCC 7375, Geminocystis herdmanii PCC 6308, Calothrix desertica PCC 7102, Rivularia sp. PCC 7116, Oscillatoriales sp. JSC-12, Geitlerinema sp. PCC 7105, Chamaesiphon minutus PCC 6605, cyanobacterium PCC 7702, Fischerella sp. PCC 9431, Synechocystis sp. PCC 6803, PCC-N, Synechocystis sp. PCC 6803, GT-I, Fischerella sp. PCC 9605, Fischerella sp. PCC 9339, Synechococcus sp. CC96 16, Mastigocladopsis repens PCC 10914, Cyanobacterium sp. ESFC-1, Leptolyngbya sp. PCC 6406, Synechocystis sp. PCC 7509, Synechocystis sp. PCC 6803, PCC-P, Synechocystis sp. PCC 6803, Anabaena sp. 90, Synechocystis ADH, Zymomonas PDC, Escherichia coli-PAL2-FDC1, Escherichia coli HB 101/pBU11, Escherichia albertii, Escherichia fergusonii, Escherichia hermannii Escherichia marmotae[2], Escherichia vulneris, Pseudomonas D2, Pseudomonas F2, Myxococcus xanthus, Myxococcus xanthus DK 1622, Myxococcus xanthus DZ2, Myxococcus xanthus DZF1, Myxococcus xanthus NewJersey2, Myxococcus xanthus DSMI6526T. Bacillus sphaericus, Lysinibacillus sphaericus INQCS 414, and S. pasteurii MTCC 1761 or a combination thereof. Variants, serotypes and mutations, of the foregoing may also be used.

Green algae may also be used to facilitate biomineralization. Green algae are a diverse group of photosynthetic, eukaryotic organisms that include species with haplobiontic and diplobiontic life cycles. They are classified under the kingdom Plantae and are included in the Glade Viridiplantae. The green algae include unicellular and colonial flagellates, most with two flagella per cell, as well as various colonial, coccoid and filamentous forms, and macroscopic, multicellular seaweeds. There are about 22,000 species of green algae. Green algae have chloroplasts that contain chlorophyll a and b, giving them a bright green color, as well as the accessory pigments beta carotene (red-orange) and xanthophylls (yellow) in stacked thylakoids. The cell walls of green algae usually contain cellulose, and they store carbohydrate in the form of starch. All green algae have mitochondria with flat cristae. When present, paired flagella are used to move the cell. They are anchored by a cross-shaped system of microtubules and fibrous strands.

Species of green algae that may be used in biomineralization include members of Prasinodermophyta, Palmophyllophyceae (prasinophyte Glade VI), Prasinodermophyceae, Chlorophytina, Ulvophyceae, Chlorophyceae, Trebouxiophyceae, Chlorodendrophyceae, Pedinophyceae, Prasinophytes Clade VIIA, Prasinophytes Clade VIIC, Pycnococcaceae, Nephroselmidophyceae, Mamiellophyceae, Pyramimonadales, Streptophyta/Mesostigmatophyceae, Spirotaenia, Chlorokybophyceae, Streptofilum, Klebsormidiophyceae, Phragmoplastophyta, Charophyceae, Coleochaetophyceae, Zygnematophyceae, Mesotaeniaceae s.s., or a combination thereof. Calcareous green algae belong to the three groups: (1) Codiaceae, (2) Dasycladaceae, and (3) Charophyceae.

Examples of green algae include Chlorella vulgaris, Ulva lactuca, Caulerpa taxifolia, Nannochloropsis sp., Chlamydomonas reinhardtii, Volvox carteri, Dunaliella salina, Chara sp., Scenedesmus sp., Cladophora sp., and Trebouxia sp., or a combination thereof.

The second microorganisms that use nitrogen to produce the second binder are preferably urease producing prokaryotic or eukaryotic cells, in particular bacteria, yeast, or algae, or a combination thereof.

The prokaryotic microorganisms may comprise cells of Sporosarcina pasteurii, Sporosarcina ureae, Proteus vulgaris, Bacillus sphaericus, Myxococcus xanthus, Proteus mirabilis, Helicobacter pylori, or variants, serotypes, mutations, or a combination thereof.

The first microorganisms that use carbon dioxide to produce the first binder are present in the dry composition in an amount of 1×10⁴ to 1×10¹² cells, preferably 1×10⁶ to 1×10¹⁰ cells and more preferably 1×10⁷ to 1×10⁹ cells based on a total weight of the dry composition.

The second microorganisms when present use nitrogen to produce the second binder. The second microorganisms that use nitrogen to produce the second binder are present in the dry composition in an amount of 1×10⁴ to 1×10¹² cells, preferably 1×10⁶ to 1×10¹⁰ cells and more preferably 1×10⁷ to 1×10⁹ cells based on a total weight of the dry composition.

The cell ratio of first microorganisms to second microorganisms is 1:6 to 9:1, preferably 1:2 to 8:1 in the environmentally friendly dry composition.

In an embodiment, the first binder produced by the first microorganism (that consumes carbon dioxide) is calcium carbonate. The calcium carbonate may be in one of three crystalline forms when produced initially. These are vaterite, aragonite and calcite. It is desirable to have the calcite form the majority of the first binder. In an embodiment, the calcium carbonate is present in the bio-cement in an amount of 0.1 to 51 weight percent, based on a total weight of the bio-cement. The bio-cement is the product produced after the removal of the aqueous media (i.e., after activation and settling).

The microorganisms produce the same final product, or “binder”, which is calcium carbonate. In the first microorganism, the carbonate ultimately comes from the atmospheric CO₂, bicarbonate salts, or carbonate salts. In the second microorganism, the carbonate ultimately comes from urea.

In an embodiment, the first binder produced by the second microorganism (that consumes urea) is calcium carbonate. The calcium carbonate may be in one of three crystalline forms when produced initially. These are vaterite, aragonite and calcite. It is desirable to have the calcite form the majority of the first binder. In an embodiment, the calcium carbonate is present in the bio-cement in an amount of 0.1 to 51 weight percent, based on a total weight of the bio-cement. The bio-cement is the product produced after the removal of the aqueous media (i.e., after activation and settling). In an embodiment, the micro-organism is present in the bio-cement in an amount of 0.01 to 25 weight percent, where the first binder is present in the bio-cement in an amount of 0.01 to 75 weight percent and where the nutrient is present in the bio-cement in an amount of 0.01 to 10 weight percent, based on the total weight of the bio-cement.

### Nutrients

The nutrients are consumed by the microorganisms along with gases from the atmosphere (carbon dioxide, nitrogen, and the like) to produce the first binder during the bio-mineralization process. The term “nutrient” as used herein refers to any chemical compound or composition which provides for microorganism growth or function. For example, for calcium-precipitating bacteria, a source of calcium is a nutrient. For polymer-forming bacteria, glucose can be a nutrient which the bacteria converts to a polymeric material. Co-factors which support bacteria viability (e.g., trace elements) are considered nutrients. The disclosed nutrient media comprise ingredients which provide for microorganism growth, as well as, the flowability of the bio-cement. Microorganism growth materials include inorganic salts and sources of carbon for microorganism metabolism. Some of the nutrients can serve as the binder and some of the binder can function as nutrients.

Suitable nutrients include inorganic salts, especially those that contain calcium. Cations from these salts can include hydrogen, lithium, aluminium, barium, calcium, chromium(III), copper(I), copper(II), gold(I), gold(III), iron(II), iron(III), lead(II), lead(IV), magnesium, manganese(II), manganese(III), manganese(IV), potassium, molybdenum, cobalt, nickel, silicon, titanium, zirconium, silver, sodium, strontium, tin(II), tin (IV), zinc, or a combination thereof. Anions include chloride, sulfate, nitrate, nitrite, phosphate, borate, carbonate, bicarbonate, sulfite, bisulfite, boride, iodide, bromide, hydride, oxide, fluoride, sulfide, chloride, nitride, bromide, iodide, oxoanions, arsenate, phosphate, arsenite, hydrogen phosphate, dihydrogen phosphate, sulfate, nitrate, hydrogen sulfate, thiosulfate, sulfite, perchlorate, iodate, chlorate, bromate, chlorite, hypochlorite, hypobromite, carbonate, chromate, hydrogen carbonate or bicarbonate, dichromate, anions from organic acids (e.g., acetate, formate, or the like), cyanide, amide, cyanate, peroxide, thiocyanate, oxalate, hydroxide, permanganate, or a combination thereof.

Calcium salts are preferred. In an embodiment, the binder precipitated by the microorganism may react with other nutrients to form reaction products that are present as a part of the binder.

Non-limiting examples of inorganic ingredients that may be used as nutrients include CO₂, NaCl, KCl, MgSO₄, CaCl₂, NaNO₃, KH₂PO₄, H₃BO₄, ZnCl₂, MoO₃, MnCF, CoCl₂, ammonia, ammonium, ammonium phosphate, ammonium carbonate, diammonium phosphate, calcium acetate, calcium phosphate, calcium carbonate, sodium carbonate, sodium bicarbonate, calcium lactate, calcium nitrate, or a combination thereof.

Non-limiting examples of organic ingredients include organic acids (acetate) and salts thereof, tris(hydroxymethyl)aminomethane and salts thereof, ethylenediamine tetraacetic acid and salts thereof, glucose, galactose, fructose and the like.

The nutrients are added in an amount of 0.0000001 to 10 weight percent based on the weight of the liquid media, the nutrients and the microorganisms based on the total weight of the biomineralized microorganism package. The biomineralized microorganism package is the weight of the package prior to the drying (desiccation) of the package.

### Liquid Media

The liquid media is added to the plurality of microorganisms along with the nutrients to facilitate growth and reproduction of the microorganisms to form the microorganism package. The liquid media is preferably an aqueous media. Other non-aqueous liquids may also be used to facilitate growth of the microorganisms. The non-aqueous liquids may be compatible with the aqueous media or may not be compatible with the aqueous media.

In a preferred embodiment, the liquid media is water. Other organic liquids such as alcohols may be added to the mixture of microorganisms and nutrients. Examples of suitable alcohols include ethanol, propanol, butanol, and the like, or a combination thereof.

The liquid media is added in an amount of 90 to 99.99999 weight percent based on the weight of the liquid media, the nutrients and the microorganisms based on the total weight of the biomineralized microorganism package. The biomineralized microorganism package is the weight of the package prior to the drying (desiccation) of the package.

### Desiccation 106, Formation of Bio-Cement 108 and Transportation of Bio-Cement 110

The biomineralized microorganism package produced in the biomineralization process 104 are then subjected to drying or desiccation 106 to remove the liquid media (e.g., water and/or alcohol) and to leave behind the microorganisms with the binder (e.g., the binder may comprise the first binder, the second binder and/or the third binder). As noted above, during desiccation the microorganism may be protected with chemical compounds, herein referred to as desiccation tolerance. The chemical compounds can be produced endogenously by the microorganism or provided exogenously. The biomineralized microorganism package upon drying is also termed a dried biomineralized microorganism package.

The drying may be conducted by freeze drying, drum drying, spray drying, or other methods. The drying may be conducted (via spray drying) at an elevated temperature by spraying the ingredients into a region of elevated temperature. Spray drying is a method of forming a dry powder from a liquid or slurry by producing small droplets in a chamber at an elevated temperature. The elevated temperature is low enough and droplet residence time is short enough to not damage or destroy the microorganisms but high enough to facilitate evaporation of the moisture. The spray dryers may use some type of atomizer or spray nozzle to disperse the liquid or slurry into a controlled drop size spray.

The drying of the composition may also involve freeze drying, where the liquid or slurry is converted to a dry powder through lyophilization. Freeze drying, also known as lyophilization or cryodesiccation, is a low temperature dehydration process that involves freezing the product and lowering pressure, removing the ice by sublimation.

The dried biomineralized microorganism package is then subjected to optional pulverization 108 to form a powdered bio-cement. The dried biomineralized microorganism may be pulverized to break down any aggregates, before or during the blending process. Pulverization can be conducted in a ball mill, Henschel mixture, waring blender, kneader, and the like, which apply shear and elongational forces to the dry composition. Additionally, the ingredients of the dried composition may be dried to remove any moisture. The bio-cement therefore comprises the microorganisms surrounded by the first binder that has been pulverized or ground to a certain size. The bio-cement is also called a ready-mix. The pulverization facilitates homogeneous distribution during the formation of a bio-concrete.

The availability of the composition as a dry powder (the bio-cement) is advantageous because it can be sold as a light-weight kit that can be transported to a site where it is to be used and activated at the site for use. At the site, one or more of additional micro-organisms, additional binder (e.g., a synthetic polymer and/or a biopolymer that can nucleate any of the biominerals), a substrate (e.g., sand) may be added to the dry composition along with the second liquid medium.

This permits the transport of a lighter material to the point of use, which saves costs and also results in lower fuel consumption. Since the material is activated and used at room temperature without any external heating, it also results in energy savings and reduced contamination in the form of reduced emissions of carbonaceous gases. Carbonaceous gases are typically released into the atmosphere when energy (especially in the form of electricity) is produced. This process is therefore environmentally friendly in that it facilitates the removal of carbon dioxide from the atmosphere in order to produce the bio-cement.

The homogeneous bio-cement may then be packaged and transported 110 to a site for further processing. The site (where further operations are conducted) is generally remote from where the original operations (processes 102 through 110) were conducted.

### Formation of Bio-Concrete 112 and Activation of Bio-Concrete 114

The further operations conducted (with reference once again to the FIGS. 1, 2 and 3) including mixing an aggregate with the bio-cement to form a bio-concrete. This is depicted in the FIG. 1 as process 112. Following the formation of the bio-concrete, it may be activated and molded into blocks that may be used for construction purposes, amongst other things.

The aggregate comprises a substrate (also called a scaffold), a binder, additional binder (e.g. (bio)polymers), and additional liquid (which may be a second liquid). The aggregate is mixed with the bio-cement to form the bio-concrete. The various materials that may be used in the aggregate are detailed below.

### Substrate

The substrate (or scaffolds) forms the majority of the bio-concrete and is therefore preferably an inexpensive material and preferably a light weight material. In an embodiment, the substrate may be inert to the binder. In another embodiment, the substrate may undergo a reaction with the first and/or second binders. The reaction may involve the formation of a covalent bond or an ionic bond between the binders and the substrate. The substrate provides the bio-cement with reinforcement. It is therefore desirable for the substrate to be inert to the atmosphere and its contents (e.g., oxygen and moisture). The substrate is preferably uniformly dispersed throughout the binder and may be either in the form of particles, fibers, or a combination thereof.

The binder produced by the microorganism along with the additional binder (e.g., (bio)polymers) added as part of the aggregate contacts the substrate and bonds the substrate together. The binder forms the matrix of the bio-cement despite not being the majority fraction of the bio-concrete. The substrates may be electrically inert or electrically conducting. Electrically conducting fillers may be added to the bio-cement in amounts effective to render the bio-cement electrically conducting. Electrically conducting bio-cements may be used in buildings where electrostatic dissipation and/or electromagnetic shielding is desired.

### Ceramic Substrates

Suitable particulate substrates include ceramics, metals, polymers, or a combination thereof. Ceramic substrates include metal oxides (e.g., sand, silica, fumed silica, alumina, fumed alumina, titania, zirconia, ceria, metal oxide aerogels, or the like, or a combination thereof), metal carbides, metal nitrides, metal borides, metal silicides, metal oxycarbides, metal oxynitrides, metal boronitrides, metal carbonitrides, metal borocarbides, or the like, or a combination thereof. Examples of ceramics that may be used as the substrate include silicon dioxide, aluminum oxide, aluminum silicate, hydrated calcium, hydrated aluminum, titanium dioxide, indium tin oxide, antimony tin oxide, cerium oxide, cadmium-oxide, titanium nitride, silicon nitride, aluminum nitride, titanium carbide, silicon carbide, titanium niobium carbide, stoichiometric silicon boride compounds (SiBₙ, where n=14, 15, 40, and so on) (e.g., silicon triboride, SiB₃, silicon tetraboride, SiB₄, silicon hexaboride, SiB₆, or the like), or the like, or a combination thereof. A preferred ceramic substrate is sand.

The ceramic substrates may have a size of 10 nanometers to 5000 micrometers, preferably 100 nanometers to 2000 micrometers, and more preferably 150 nanometers to 1500 micrometers.

### Carbon Black

Carbon black may also be used in the composition. Preferred conductive carbon blacks may also have surface areas greater than about 200 square meter per gram (m²/g), preferably greater than about 400 m²/g, yet more preferably greater than about 1000 m²/g. Preferred conductive carbon blacks may have a pore volume (dibutyl phthalate absorption) greater than about 40 cubic centimeters per hundred grams (cm³/100 g), preferably greater than about 100 cm³/100 g, more preferably greater than about 150 cm³/100 g. Exemplary carbon blacks include the carbon black commercially available from Columbian Chemicals under the trade name Conductex®; the acetylene black available from Chevron Chemical, under the trade names S.C.F. (Super Conductive Furnace) and E.C.F. (Electric Conductive Furnace); the carbon blacks available from Cabot Corp. under the trade names Vulcan XC72 and Black Pearls; and the carbon blacks commercially available from Akzo Co. Ltd under the trade names Ketjen Black EC 300 and EC 600. Preferred carbon blacks are those having average particle sizes less than about 100 nm, preferably less than about 70 nm, more preferably less than about 50 nm. Preferred carbon blacks may be used in amounts from about 0.1 wt % to about 50 wt %, preferably 5 to 40 wt %, based on the total weight of the environmentally friendly dry composition.

Solid conductive metallic fillers may also optionally be used in the composition. Metals such as aluminum, copper, magnesium, chromium, tin, nickel, silver, iron, titanium, and mixtures comprising any one of the foregoing metals can be incorporated into the composition as conductive fillers. Physical mixtures and true alloys such as stainless steels, bronzes, and the like, may also serve as conductive filler particles. In addition, a few intermetallic chemical compounds such as borides, carbides, and the like, of these metals, (e.g., titanium diboride) may also serve as conductive filler particles. Solid non-metallic, conductive filler particles such as tin-oxide, indium tin oxide, and the like may also optionally be added to reinforce the composition or to render the composition electrically conductive.

In some embodiments, the size (e.g., the average size, median size, or minimum size) of the metallic fillers along one or two major dimensions may be at least 0.1 μm, 0.5 μm, 1 μm, 5 μm, 10 μm, 50 μm, 100 μm, 200 μm, 300, μm, 400 μm, 500 μm, 600 μm, 7000 μm, 800 μm, 900 μm, 1,000 μm or more. For example, in some embodiments, the size (e.g., the average size, median size, or minimum size) of the elements may be in the range of 1 μm to 1,000 μm, or any subrange thereof, such as 1 μm to 600 μm.

In some embodiments, the size of the elements can be relatively uniform. For example, in some embodiments, more than 50%, 60%, 70%, 80%, 90%, 95%, 99% or more of the elements may have a size along one or two major dimensions within 10% of the average size for the elements.

Functionalizing the particulate substrates generally includes a surface treatment. Surface treatment may be performed by any suitable technique such as those described herein or known in the art. Functional groups applied to the particulate substrates may be selected to promote adhesion between the other components of the composition and the substrates. For example, in various embodiments the functional groups may include carboxylic groups, carbonyl groups, ester groups, hydroxyl groups, amine groups, silane groups, thiol groups, phosphate groups, or combinations thereof.

In some embodiments, surface treatment of the particulate substrates includes a thin polymeric layer disposed on the substrate that promotes adhesion of the active material to the network. In some such embodiments the thin polymeric layer comprises a self-assembled and or self-limiting polymer layer. In some embodiments, the thin polymeric layer bonds to the ingredients of the composition, e.g., via hydrogen bonding.

### Glass Beads and Crushed Glass

Glass beads or crushed glass may also be used to reinforce the composition. The glass beads or crushed glass may comprise SiO₂, B₂O₃, P₂O₅, GeO₂, TeO₂, As₂O₃, Al₂O₃, TiO₂, ZrO₂, V₂O₅, or a combination thereof. The average size of the glass beads or crushed glass may range from 1 micrometer to 5 millimeters, preferably 10 micrometers to 2.5 millimeters. The glass beads or crushed glass may also be coated with a polymer to render it compatible with the composition.

Particulates in the form of carbon black, glass beads, and the like, may be added to the composition in an amount of 0.5 to 60 wt %, preferably 1 to 50 wt %, preferably 2 to 40 wt %, and more preferably 3 to 20 wt %, based on the weight of the environmentally friendly dry composition.

### Fibrous Fillers

The substrates can also be in the form of fibers. The fibers can include carbon nanotubes, textile fibers, carbon fibers, glass fibers, metal fibers, and the like.

The fibers can have diameters that are in the nanometer size range (2 to 100 nanometers) or in the micrometer range (101 nanometers to 500 micrometers). Examples of fibers in the nanometer size range include nanotubes (e.g., carbon nanotubes (single wall carbon nanotubes (SWNTs), double wall carbon nanotubes (DWNTs), multiwall carbon nanotubes (MWNTs), vapor grown carbon fibers, silicon nanotubes, and the like); metallic nanorods or nanowires (e.g., silicon, copper, silver, nickel, and the like), metal oxide nanorods and nanowires (e.g., titanium dioxide nanowires, alumina nanowires, silica nanowires, vanadium oxide nanowires, nickel oxide nanowires, iron oxide nanowires, tungsten oxide nanowires, and the like). Combinations of the foregoing nanowires, nanotubes, nanorods, may also be used in the environmentally friendly dry composition (and in the bio-cement).

Fibers may have an average aspect ratios greater than 3, preferably greater than 5, preferably greater than 10, preferably greater than 100, preferably greater than 1000 upto a value of 100,000. The aspect ratio is the ratio of a major dimension (e.g., length) to a minor dimension (e.g., a diameter or a width) of the fibers.

SWNTs used in the composition may be produced by laser-evaporation of graphite, carbon arc synthesis or the high-pressure carbon monoxide conversion process (HIPCO) process. These SWNTs generally have a single wall comprising a graphene sheet with outer diameters of about 0.7 to about 2.4 nanometers (nm). SWNTs having aspect ratios of greater than or equal to about 5, preferably greater than or equal to about 100, more preferably greater than or equal to about 1000 are generally utilized in the composition. While the SWNTs are generally closed structures having hemispherical caps at each end of the respective tubes, it is envisioned that SWNTs having a single open end or both open ends may also be used. The SWNTs generally comprise a central portion, which is hollow, but may be filled with amorphous carbon.

In an exemplary embodiment, the purpose of dispersion of the SWNTs in an organic polymer is to disentangle the SWNTs so as to obtain an effective aspect ratio that is as close to the aspect ratio of the SWNT as possible. The ratio of the effective aspect ratio to the aspect ratio is a measure of the effectiveness of dispersion. The effective aspect ratio is a value that is twice the radius of gyration of a single SWNT divided by the outer diameter of the respective individual nanotube. It is generally desirable for the average value of ratio of the effective aspect ratio to the aspect ratio to be greater than or equal to about 0.5, preferably greater than or equal to about 0.75, and more preferably greater than or equal to about 0.90, as measured in an electron micrograph at a magnification of greater than or equal to about 10,000.

In one embodiment, the SWNTs may exist in the form of rope-like-aggregates. These aggregates are commonly termed “ropes” and are formed as a result of Van der Waal's forces between the individual SWNTs. The individual nanotubes in the ropes may slide against one another and rearrange themselves within the rope in order to minimize the free energy. Ropes generally having between 10 and 10⁵ nanotubes may be used in the compositions. Within this range, it is generally desirable to have ropes having greater than or equal to about 100, preferably greater than or equal to about 500 nanotubes. Also desirable, are ropes having less than or equal to about 104 nanotubes, preferably less than or equal to about 5,000 nanotubes.

In yet another embodiment, it is desirable for the SWNT ropes to connect each other in the form of branches after dispersion. This results in a sharing of the ropes between the branches of the SWNT networks (or the carbon nanotube network) to form a 3-dimensional network in the organic polymer matrix. A distance of about 10 nm to about 10 micrometers may separate the branching points in this type of network. It is generally desirable for the SWNTs to have an inherent thermal conductivity of at least 2000 Watts per meter Kelvin (W/m-K) and for the SWNT ropes to have an inherent electrical conductivity of 10⁴ Siemens/centimeter (S/cm). It is also generally desirable for the SWNTs to have a tensile strength of at least 80 gigapascals (GPa) and a stiffness of at least about 0.5 tarapascals (TPa).

In another embodiment, the SWNTs may comprise a mixture of metallic nanotubes and semi-conducting nanotubes. Metallic nanotubes are those that display electrical characteristics similar to metals, while the semi-conducting nanotubes are those, which are electrically semi-conducting. In general, the manner in which the graphene sheet is rolled up produces nanotubes of various helical structures. Zigzag and armchair nanotubes constitute two possible confirmations. In order to minimize the quantity of SWNTs utilized in the composition, it is generally desirable to have the composition comprise as large a fraction of metallic SWNTs. It is generally desirable for the SWNTs used in the composition to comprise metallic nanotubes in an amount of greater than or equal to about 1 wt %, preferably greater than or equal to about 20 wt %, more preferably greater than or equal to about 30 wt %, even more preferably greater than or equal to about 50 wt %, and most preferably greater than or equal to about 99.9 wt % of the total weight of the SWNTs. In certain situations, it is generally desirable for the SWNTs used in the composition to comprise semi-conducting nanotubes in an amount of greater than or equal to about 1 wt %, preferably greater than or equal to about 20 wt %, more preferably greater than or equal to about 30 wt %, even more preferably greater than or equal to about 50 wt %, and most preferably greater than or equal to about 99.9 wt % of the total weight of the SWNTs.

SWNTs are generally used in amounts of about 0.001 to about 80 wt % of the total weight of the composition when desirable. Within this range, SWNTs are generally used in amounts greater than or equal to about 0.25 wt %, preferably greater or equal to about 0.5 wt %, more preferably greater than or equal to about 1 wt % of the total weight of the composition. SWNTs are furthermore generally used in amounts less than or equal to about 30 wt %, preferably less than or equal to about 10 wt %, more preferably less than or equal to about 5 wt % of the total weight of the environmentally friendly dry composition (and in the bio-cement).

The nanosized conductive filler are those having at least one dimension less than or equal to about 1,000 nm. The nanosized conductive fillers may be 1, 2 or 3-dimensional and may exist in the form of powder, drawn wires, strands, fibers; tubes, nanotubes, rods, whiskers, flakes, laminates, platelets, ellipsoids, discs, spheroids, and the like, or combinations comprising at least one of the foregoing forms. They may also have fractional dimensions and may exist in the form of mass or surface fractals.

Suitable examples of nanosized conductive fillers (also referred to herein as high aspect ratio carbon elements) are multiwall carbon nanotubes (MWNTs), vapor grown carbon fibers (VGCF), carbon black, graphite, conductive metal particles, conductive metal oxides, metal coated fillers, nanosized conducting organic/organometallic fillers, conductive polymers, and the like, and combinations comprising at least one of the foregoing nanosized conductive fillers.

MWNTs derived from processes such as laser ablation and carbon arc synthesis that are not directed at the production of SWNTs, may also be used in the compositions. MWNTs have at least two graphene layers bound around an inner hollow core. Hemispherical caps generally close both ends of the MWNTs, but it may be desirable to use MWNTs having only one hemispherical cap or MWNTs, which are devoid of both caps. MWNTs generally have diameters of about 2 to about 50 nm. Within this range, it is generally desirable to use MWNTs having diameters less than or equal to about 40, preferably less than or equal to about 30, and more preferably less than or equal to about 20 nm. When MWNTs are used, it is preferred to have an average aspect ratio greater than or equal to about 5; preferably greater than or equal to about 100, more preferably greater than or equal to about 1000.

MWNTs are generally used in amounts of about 0.001 to about 50 wt % of the total weight of the composition when desirable. Within this range, MWNTs are generally used in amounts greater than or equal to about 0.25 wt %, preferably greater or equal to about 0.5 wt %, more preferably greater than or equal to about 1 wt % of the total weight of the composition. MWNTs are furthermore generally used in amounts less than or equal to about 30 wt %, preferably less than or equal to about 10 wt %, more preferably less than or equal to about 5 wt % of the total weight of the composition.

### Vapor Grown Carbon Fibers

Vapor grown carbon fibers or small graphitic or partially graphitic carbon fibers, also referred to as vapor grown carbon fibers (VGCF), having diameters of about 3.5 to about 100 nanometers (nm) and an aspect ratio greater than or equal to about 5 may also be used. These vapor grown carbon fibers typically contain an amorphous coating on the exterior surface of the graphitic carbon fiber surface. When VGCF are used, diameters of about 3.5 to about 70 nm are preferred, with diameters of about 3.5 to about 50 nm being more preferred, and diameters of about 3.5 to about 25 nm most preferred. It is also preferable to have average aspect ratios greater than or equal to about 100 and more preferably greater than or equal to about 1000.

VGCF are generally used in amounts of about 0.001 to about 50 wt % of the total weight of the composition when desirable. Within this range, VGCF are generally used in amounts greater than or equal to about 0.25 wt %, preferably greater or equal to about 0.5 wt %, more preferably greater than or equal to about 1 wt % of the total weight of the composition. VGCF are furthermore generally used in amounts less than or equal to about 30 wt %, preferably less than or equal to about 10 wt %, more preferably less than or equal to about 5 wt % of the total weight of the high aspect ratio conductive element.

Both the SWNTs and the other carbon nanotubes (i.e., the MWNTs and the VGCF) utilized as the high aspect ratio carbon elements may also be derivatized with functional groups to improve compatibility and facilitate the mixing with the microorganisms and the nutrients. The SWNTs and the other carbon nanotubes may be functionalized on either the graphene sheet constituting the sidewall, a hemispherical cap or on both the side wall as well as the hemispherical endcap. Functionalized SWNTs and the other carbon nanotubes are those having the formula [CₙH_{L}]Rₘ wherein n is an integer, L is a number less than 0.1n, m is a number less than 0.5 n, and wherein each of R is the same and is selected from —SO₃H, —NH₂, —OH, —C(OH)R′, —CHO, —CN, —C(O)Cl, —C(O)SH, —C(O)OR′, —SR′, —SiR₃′, —Si(OR′)_{y}R′_{(3-y)}, —R″, —AlR₂′, halide, ethylenically unsaturated functionalities, epoxide functionalities, or the like, wherein y is an integer equal to or less than 3, R′ is hydrogen, alkyl, aryl, cycloalkyl, alkaryl, aralkyl, cycloaryl, poly(alkylether), bromo, chloro, iodo, fluoro, amino, hydroxyl, thio, phosphino, alkylthio, cyano, nitro, amido, carboxyl, heterocyclyl, ferrocenyl, heteroaryl, fluoro substituted alkyl, ester, ketone, carboxylic acid, alcohol, fluoro-substituted carboxylic acid, fluoro-alkyl-triflate, or the like, and R″ is fluoroalkyl, fluoroaryl, fluorocycloalkyl, fluoroaralkyl, cycloaryl, or the like. The carbon atoms, Cₙ, are surface carbons of a carbon nanotube. In both, uniformly and non-uniformly substituted SWNTs and other carbon nanotubes, the surface atoms Cₙ are reacted.

Non-uniformly substituted SWNTs and other carbon nanotubes may also be used in the conductive precursor composition and/or the conductive composition. These include compositions of the formula (I) shown above wherein n, L, m, R and the SWNT itself are as defined above, provided that each of R does not contain oxygen, or, if each of R is an oxygen-containing group, COOH is not present.

Also included are functionalized SWNTs and other carbon nanotubes having the formula:

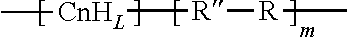

where n, L, m, R″ and R have the same meaning as above. Most carbon atoms in the surface layer of a carbon nanotube are basal plane carbons. Basal plane carbons are relatively inert to chemical attack. At defect sites, where, for example, the graphitic plane fails to extend fully around the carbon nanotube, there are carbon atoms analogous to the edge carbon atoms of a graphite plane. The edge carbons are reactive and must contain some heteroatom or group to satisfy carbon valency.

The substituted SWNTs and other carbon nanotubes described above may advantageously be further functionalized. Such SWNT compositions include compositions of the formula:

[CnH_{L}]Aₘ
where n, L and m are as described above, A is selected from —OY, —NHY, —CR′₂—OY, —C(O)OY, —C(O)NR′Y, —C(O)SY, or —C(O)Y, wherein Y is an appropriate functional group of a protein, a peptide, an enzyme, an antibody, a nucleotide, an oligonucleotide, an antigen, or an enzyme substrate, enzyme inhibitor or the transition state analog of an enzyme substrate or is selected from —R′OH, —R′NH₂, —R′SH, —R′CHO, —R′CN, —R′X, —R′SiR′₃, —RSi—(OR′)_{y}—R′_{(3-y)}, —R′Si—(O—SiR′₂)—OR′, —R′—R″, —R′—NCO, (C₂H₄O)_{w}Y, —(C₃H₆O)_{w}H, —(C₂H₄O)_{w}R′, —(C₃H₆O)_{w}R′ or —(C₃H₆O)_{w}R″, wherein w is an integer greater than one and less than 200. R′ and R″ are defined above.

The functional SWNTs and other carbon nanotubes of structure shown immediately above may also be functionalized to produce SWNT compositions having the formula:

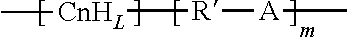

where n, L, m, R′ and A are as defined above.

The conductive precursor composition and/or the conductive composition may also include SWNTs and other carbon nanotubes upon which certain cyclic compounds are adsorbed. These include SWNT compositions of matter of the formula:

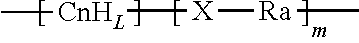

where n is an integer, L is a number less than 0.1n, m is less than 0.5 n, a is zero or a number less than 10, X is a polynuclear aromatic or a polyheteronuclear aromatic moiety and R is as recited above. Preferred cyclic compounds are planar macrocycles such as re porphyrins and phthalocyanines.

The adsorbed cyclic compounds may be functionalized. Such SWNT compositions include compounds of the formula:

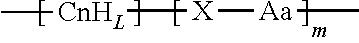

where m, n, L, a, X and A are as defined above and the carbons are on the SWNT or on other nanotubes such as MWNTs, VGCF, or the like.

Without being bound to a particular theory, the functionalized SWNTs and other carbon nanotubes are better dispersed into the environmentally friendly dry composition (and in the bio-cement) because the modified surface properties may render the carbon nanotube more compatible with the organic polymer, or, because the modified functional groups (particularly hydroxyl or amine groups) are bonded directly to the organic polymer as terminal groups. In this way, organic polymers such as polycarbonates, polyamides, polyesters, polyetherimides, or the like, bond directly to the carbon nanotubes, thus making the carbon nanotubes easier to disperse with improved adherence to the organic polymer, when an organic polymer is dispersed in the environmentally friendly dry composition (and in the bio-cement).

Functional groups may generally be introduced onto the outer surface of the SWNTs and the other carbon nanotubes by contacting the respective outer surfaces with a strong oxidizing agent for a period of time sufficient to oxidize the surface of the SWNTs and other carbon nanotubes and further contacting the respective outer surfaces with a reactant suitable for adding a functional group to the oxidized surface. Preferred oxidizing agents are comprised of a solution of an alkali metal chlorate in a strong acid. Preferred alkali metal chlorates are sodium chlorate or potassium chlorate. A preferred strong acid used is sulfuric acid. Periods of time sufficient for oxidation are about 0.5 hours to about 24 hours.

### Polymeric Fibers, Glass Fibers and Carbon Fibers

Woven fibers, non-woven fibers, or a combination thereof may be added to the composition. The woven and non-woven fibers can be a mineral fiber, a plant fiber, a synthetic fiber, or a combination thereof. Exemplary woven and non-woven fibers include glass fiber, glass wool fiber, mineral wool fiber, slag wool fiber, stone wool fiber, basalt fiber, silica fiber, quartz fiber, alumina fiber, steel fiber, silicon carbide fiber, acrylic fiber, carbon fiber, melamine fiber, cotton fiber, jute fiber, kenaf fiber, bamboo fiber, abaca fiber, hemp fiber, linen fiber, flax fiber, or a combination thereof. Woven and non-woven fibers can also be manufactured from polymers. A combination of two or more non-woven fibers can be used. The non-woven fiber can be a carbon fiber. A preferred fiber is an abaca fiber.

The glass fiber can be E, A, C, ECR, R, S, D, or NE glass, or the like, or a combination thereof. The glass fibers can be made by standard processes, e.g., by steam or air blowing, flame blowing, and mechanical pulling. Exemplary glass fibers are made by mechanical pulling.

Glass fibers are about 1 to 30 micrometers, preferably 5 to 20 micrometers in diameter.

Carbon fibers are about 1 to 30 micrometers in diameter and composed mostly of carbon atoms. Carbon fibers have several advantages: high stiffness, high tensile strength, high strength to weight ratio, high chemical resistance, high-temperature tolerance, and low thermal expansion. These properties have made carbon fiber very popular in aerospace, civil engineering, military, motorsports, and other competition sports. Depending upon the precursor to make the fiber, carbon fiber may be turbostratic or graphitic, or have a hybrid structure with both graphitic and turbostratic parts present. In turbostratic carbon fiber the sheets of carbon atoms are haphazardly folded, or crumpled, together. Carbon fibers derived from polyacrylonitrile (PAN) are turbostratic, whereas carbon fibers derived from mesophase pitch are graphitic after heat treatment at temperatures exceeding 2200° C. Turbostratic carbon fibers tend to have high ultimate tensile strength, whereas heat-treated mesophase-pitch-derived carbon fibers have high Young's modulus (i.e., high stiffness or resistance to extension under load) and high thermal conductivity.

The fibers disclosed above can be continuous or chopped. Fibers in the form of chopped strands can have a length of 0.3 millimeters (mm) to 10 centimeters (cm), or 0.5 mm to 5 cm, or 1.0 mm to 2.5 cm. For example, the fiber can have a length from 0.2-20 mm, or 0.2-10 mm, or 0.7-7 mm. The fibers can have any cross-section, such as a round (or circular), flat, or irregular cross-section. For example, the fiber has a circular cross-section. The diameter of the fiber can be from 1-25 micrometers (μm), or 3-20 μm, or 4-18 μm, or 5-17 μm. For example, the fiber can be a short glass fiber having a diameter of 10 μm. Flat glass or bilobe fibers can be used to provide, for example, low warp-high strength articles.

The woven fiber and/or non-woven fiber may be processed with, or coated with, a binder including a binder reactive functional group to form the reactive fiber system. For example, the reactive fiber system can be a wet laid mat of non-woven fibers and binder. The choice of binder is not particularly limited, provided the binder compound includes the binder reactive functional group. The binder reactive functional group can be hydroxyl, carboxyl, carboxylic anhydride, haloformyl, epoxy, silanol, amino, mercapto, vinyl, or a combination thereof. The binder reactive functional group, and the corresponding binder compound, can be selected based on the thermoplastic polymer of the reactive polymer composition and its associated reactivity. Commercially available fiber/binder systems can be used.

The aforementioned fibrous fillers may be used in the environmentally friendly dry composition (and in the bio-composition) in an amount of 0.5 to 90 wt %, preferably 1 to 85 wt %, preferably 5 to 82 wt %, and more preferably 20 to 80 wt %, based on the weight of environmentally friendly dry composition (and in the bio-cement). The solids as defined herein excludes any volatiles that can evaporate from the composition. Particulate substrates can be combined with fibrous substrates in the environmentally friendly dry composition (and in the bio-cement).

It is to be noted that the substrates may be added to the environmentally friendly dry composition in several batches. A first batch of substrates may be added to the composition (the microorganisms and the nutrients) in order to cause the microorganisms to produce the binder on the first batch of substrates. A second batch of substrates may then be added to the composition after the microorganisms have produced the binder.

The fibrous substrates may be added in a second batch to the composition after the binder has been produced by the microorganisms. The fibrous substrates may be added to the composition to provide strength and ductility to the composition.

The substrates may be added to the environmentally friendly dry composition (and the bio-cement) in an amount of 0.5 to 90 wt %, preferably 20 to 85 wt %, preferably 40 to 83 wt %, and more preferably 50 to 80 wt %, based on the total weight of the bio-concrete.

### External Second Binder

### Polymeric Additives, Impact Modifiers, Gels

As noted above, in addition to the first binder (e.g., calcium carbonate) an additional externally added binder (an external second binder) may be added as part of the aggregate. This second binder is an external binder because it is not produced by the microorganisms in the microorganism package. The external second binder is described below and binds together the substrate (the scaffolds) with the microorganism package. The external second binder may interact with the first binder to bind the substrates.

The external second binder may be an organic polymer, a gelling agent, a hydrogel, an impact modifier, recycled tires, or a combination thereof.

Organic polymers may be selected from a wide variety of thermoplastic polymers, blend of thermoplastic polymers, thermosetting polymers, or blends of thermoplastic polymers with thermosetting polymers. The organic polymer may also be a blend of polymers, copolymers, terpolymers, or combinations comprising at least one of the foregoing organic polymers. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination comprising at least one of the foregoing organic polymers. The organic polymers have number average molecular weights greater than 10,000 grams per mole, preferably greater than 20,000 g/mole and more preferably greater than 50,000 g/mole.

The various polymers are listed below. The polymeric additives may be added in the form of particles, films, solutions and suspensions in order to impart strength and ductility, resistance to water vapor, and the like, to the environmentally friendly dry composition.

Polymeric substrates can be manufactured from thermosetting or thermoplastic polymers. Thermoplastic polymers that can be used include polyacetals, polyacrylics, polycarbonates, polyalkyds, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether ether ketones, polyether ketone ketones, polybenzoxazoles, polyoxadiazoles, polybenzothiazinophenothi azines, polybenzothiazoles, polypyrazinoquinoxalines, polypyromellitimides, polyguinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polyethylene terephthalates, polyvinylidene fluorides, polysiloxanes, or the like, or a combination thereof.

Polymeric substrates can also include thermosetting substrates. Examples of thermosetting polymers suitable for use as hosts in emissive layer include epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination thereof.

In an embodiment, the polymers may be added in the form of impact modifiers to the composition. Impact modifiers may be added to improve the durability and toughness of the composition. Impact modifiers compensate for inherent brittleness, or embrittlement occurring at sub-zero temperatures, notch-sensitivity and crack propagation. The mechanism normally involves introducing a component that is elastomeric or rubbery in nature, which can absorb the energy of an impact or dissipate it. Suitable elastomers for use as impact modifiers in the composition include polybutadienes, polyisoprenes, styrene-butadiene rubber, poly(styrene)-block-poly(butadiene), poly(acrylonitrile)-block-poly(styrene)-block-poly(butadiene) (ABS), polychloroprenes, epichlorohydrin rubber, polyacrylic rubber, silicone elastomers (polysiloxanes), fluorosilicone elastomers, fluoroelastomers, perfluoroelastomers, polyether block amides (PEBA), chlorosulfonated polyethylene, ethylene propylene diene rubber (EPR), ethylene-vinyl acetate elastomers, or the like, or a combination thereof.

### Impact Modifiers and Recycled Tires

In an embodiment, impact modifiers may be added to the composition in the form of recycled tires. Concrete manufactured by the addition of impact modifiers in the form of recycled tires is called rubberized concrete. The recycled tires may first be ground into small particles of size 10 micrometers to 10 centimeters, preferably 100 micrometers to 5 centimeters.

In another embodiment, recycled concrete may be added to the composition. The recycled concrete is first ground into particles off size 10 micrometers to 10 centimeters, preferably 100 micrometers to 5 centimeters.

### Gelling Agent

In an embodiment, a gelling agent may be added to the environmentally friendly dry composition in order to improve toughness, impact resistance, ductility, and the like.

Examples of gelling agents include gelatins, alginates, carrageenans, oligosaccharides, polysaccharides, or a combination thereof. Examples of gelling agents added to the composition are hydrocolloids, examples of which are vegetable gums, a pectin blend that includes one or more of konjac, xanthan, pectin, locust bean gum and/or agar. Examples of other gelling agents that may be used include gelatin, gellan gum, carrageenan, guar gum, psyllium seed gum, yam starch powder, alginate, seaweed flour, zein, lignin, tragacanth gum, hemicellulose, karaya gum, curdlan, soy polysaccharides, alginic acid, carboxymethylcellulose, agar-agar, locust bean gum, gelatin, alginate, arabinoxylan, arrowroot, cassia gum, cellulose, gum Arabic, karaya gum, konjac, kuzu, maltodextrin, marshmallow root, pectin, sodium alginate, starch, xanthan zein, gum, b-glucan or a combination thereof.

The gelling agent is typically in the form of a dry powder prior to mixing with the water. The gelling agent is typically added at a pH of 5.0 to 7.5 when solubilized in water.

Combinations of the foregoing particulate substrates may also be used in the environmentally friendly dry composition and in the bio-cement.

### Hydrogels

In an embodiment, the composition may comprise hydrogels. The hydrogels may be added independently to the composition or may be produced by the microorganisms present in the microorganism package.

A hydrogel is a biphasic material, a mixture of porous, permeable solids and at least 10% by weight or volume of interstitial fluid composed completely or mainly by water. In hydrogels the porous permeable solid is a water insoluble three dimensional network of natural or synthetic polymers and a fluid, having absorbed a large amount of water or biological fluids.

The crosslinks which bond the polymers of a hydrogel fall under two general categories: physical hydrogels and chemical hydrogels. Chemical hydrogels have covalent cross-linking bonds, whereas physical hydrogels have non-covalent bonds. Chemical hydrogels result in strong irreversible gels due to the covalent bonding. Chemical crosslinks consist of covalent bonds between polymer strands. Hydrogels generated in this manner are sometimes called ‘permanent’ hydrogels.

Physical hydrogels on the other hand are also easily reversible, by simply changing an external stimulus such as pH, ion concentration (alginate) or temperature (gelatin). Physical crosslinks consist of ionic bonds, hydrogen bonds, hydrophobic interactions, and chain entanglements (among others). A hydrogel generated through the use of physical crosslinks is sometimes called a ‘reversible’ hydrogel.

Hydrogels are prepared using a variety of polymeric materials, which can be divided broadly into two categories according to their origin: natural or synthetic polymers. Natural polymers for hydrogel preparation include hyaluronic acid, chitosan, heparin, alginate, gelatin and fibrin. Common synthetic polymers include polyvinyl alcohol, polyethylene glycol, sodium polyacrylate, acrylate polymers and copolymers thereof.

The gelling agents listed above may be included as hydrogels and may be crosslinked the same way as hydrogels.

Hydrogels may be present in the composition in amounts of 2 to 30 wt %, preferably 5 to 15 wt %, and more preferably 7 to 12 wt %, based on the total weight of the bio-concrete.

Gelling agents (listed above) may also be used as nutrients. Gelatin and zein may also be used as nutrients in the bio-concrete. In an embodiment, the zein is a preferred external second binder. The first binder may be used in an amount of 0.5 to 95 wt %, based on a total weight of the binder used in the bio-concrete. The external second binder may be used in an amount of 5 to 95 wt %, based on a total weight of the binder used in the bio-concrete.

The external second binder may be used in amount of 2 to 30 wt %, preferably 5 to 15 wt %, and more preferably 7 to 12 wt %, based on the total weight of bio-concrete.

The aggregate may also include thermal stabilizers, antiozonants, antioxidants, mold release agents, barrier materials, inhibitors, cross-linking agents, initiators, and the like.

Crosslinking agents may be used to form covalent bonds or ionic bonds in the binders. The crosslinking agent may be used to form covalent bonds or ionic bonds in the hydrogels, gelling agents, polymeric binders, polymeric additives, impact modifiers, gels, and the like. Suitable crosslinking agents include aldehydes, carboxylic and other acids, alcohols, acrylates, isocyanates, or a combination thereof.

Examples of crosslinking agents include formaldehyde, glutaraldehyde, epichlorohydrin, citric acid, 1,2,3,4-butanetetracarboxylic acid, polymeric dialdehyde starch, 1,2-epoxy-3-chloropropane, dialcohols, acryloyl, or a combination thereof.

Other crosslinking agents that may be used to crosslink the hydrogels, gelling agents, polymeric binders, polymeric additives, impact modifiers, gels, and so on. Illustrative examples include compounds produced by condensation of an acrylic or methacrylic acid with a di-epoxide, such as bisphenol-A diglycidyl ether, butanediol diglycidyl ether, or neopenylene glycol dimethacrylate. Specific examples include 1,4-butanediol diglycidylether di(meth)acrylate, bisphenol A diglycidylether dimethacrylate, and neopentylglycol diglycidylether di(meth)acrylate, and the like. Also included as acryloyl monomers are the condensation of reactive acrylate or methacrylate compounds with alcohols or amines to produce the resulting polyfunctional acrylates or polyfunctional acrylamides. Examples include N,N-bis(2-hydroxyethyl)(meth)acrylamide, methylenebis((meth)acrylamide), 1,6-hexamethylenebis((meth)acrylamide), diethylenetriamine tris((meth)acrylamide), bis(gamma-((meth)acrylamide)propoxy) ethane, beta-((meth)acrylamide) ethylacrylate, ethylene glycol di((meth)acrylate)), diethylene glycol di(meth)acrylate, tetraethylene glycol di(meth)acrylateglycerol di (meth)acrylate, glycerol tri(meth)acrylate, 1,3-propylene glycol di(meth)acrylate, dipropyleneglycol di(meth)acrylate, 1,4-butanediol di(meth)acrylate, 1,2,4-butanetriol tri(meth)acrylate, 1,6-hexanedioldi(meth)acrylate, 1,4-cyclohexanediol di(meth) acrylate, 1,4-benzenediol di(meth)acrylate, pentaerythritoltetra(meth)acrylate, 1,5-pentanediol di(meth)acrylate, trimethylolpropane di(meth)acrylate, trimethylolpropane tri(meth)acrylate), 1,3,5-triacryloylhexahydro-1,3,5-triazine, 2,2-bis(4-(2-(meth) acryloxyethoxy)phenyl)propane, 2,2-bis(4-(2-(meth)acryloxyethoxy)-3,5-dibromophenyl)propane, 2,2-bis((4-(meth)acryl oxy)phenyl)propane, 2,2-bis((4-(meth) acryloxy)-3,5-dibromophenyl)propane, and the like, and mixtures comprising at least one of the foregoing acryloyl monomers.

Other crosslinking agents include alkoxylated difunctional monomers, such as alkoxylated diacrylate (sold as CD 802 by Sartomer Co.), alkoxylated aliphatic diacrylate, alkoxylated cyclohexane dimethanol diacrylate, alkoxylated cyclohexane dimethanol diacrylate, alkoxylated cyclohexane dimethanol diacrylate, alkoxylated hexane diol diacrylate, alkoxylated hexane diol diacrylate, alkoxylated hexane diol diacrylate, 1,4-butanediol diacrylate, 1,4-butanediol dimethacrylate, 1,3-butylene glycol diacrylate, 1,3-butylene glycol dimethacrylate, cyclohexane dimethanol diacrylate, cyclohexane dimethanol dimethacrylate, diethylene glycol diacrylate, diethylene glycol dimethacrylate, dipropylene glycol diacrylate, (ethoxylated)3 bisphenol A diacrylate (it will be understood that the number following the ethoxylated term refers to the average number of ethoxy groups in the ethoxylate chains attached to each oxygen of bisphenol A), (ethoxylated)4 bisphenol A diacrylate, (ethoxylated)10 bisphenol A diacrylate, (ethoxylated)30 bisphenol A diacrylate, (ethoxylated)2 bisphenol A dimethacrylate, (ethoxylated)4 bisphenol A dimethacrylate, (ethoxylated)6 bisphenol A diacrylate, (ethoxylated)8 bisphenol A diacrylate, (ethoxylated)10 bisphenol A dimethacrylate, (ethoxylated)30 bisphenol A dimethacrylate, ethylene glycol dimethacrylate, 1,6-hexanediol di(meth)acrylate, neopentyl glycol di(meth)acrylate, polyethylene glycol (M n=200-600) di(meth)acrylate, tetraethylene glycol di(meth) acrylate, triethylene glycol di(meth)acrylate, tripropylene glycol di(meth)acrylate, and the like; alkoxylated trifunctional monomers such as highly (propoxylated)5.5 glyceryl tri(meth)acrylate, (ethoxylated)3 trimethylolpropane tri(meth)acrylate, (ethoxylated)6 trimethylolpropane tri(meth)acrylate, (ethoxylated)15 trimethylolpropane tri(meth) acrylate, (ethoxylated)9 trimethylolpropane tri(meth)acrylate, (ethoxylated)20 trimethylolpropane tri(meth)acrylate, pentaerythritol tri(meth)acrylate, (propoxylated)3 glyceryl tri(meth)acrylate, (propoxylated)3 trimethylolpropane tri(meth)acrylate, (propoxylated)6 trimethylolpropane tri(meth)acrylate, tris (2-hydroxyethyl) isocyanurate tri(meth)acrylate solid, tris (2-hydroxyethyl) isocyanurate tri(meth) acrylate liquid, and the like; and tetrafunctional and pentafunctional monomers such as dipentaerythritol penta(meth)acrylate, di-(trimethylolpropane) tetra(meth)acrylate, (ethoxylated)4 pentaeryth ritol tetra(meth)acrylate, di pentaeryth ritol penta(meth) acrylate ester, pentaerythritol tetra(meth)acrylate, and the like; and mixtures comprising at least one of the foregoing acryloyl monomers.

Suitable acryloyl monomers may further include trifunctional urethane (meth) acrylates, such as the trifunctional urethane (meth)acrylates sold by Sartomer Company under the product names CN 929, CN 945 A60, CN 945 B85, CN 959, CN 962, CN 964, CN 965, CN 968, CN 980, CN 981, CN 983, CN 984, CN 944 B85, CN 953 B70, CN 963 B80, CN 964B85, CN 966 B85, CN 981 B88, CN 982 B88, CN 983 B88, CN 985 B88, CN 961H81, CN 966H90, CN 982 P90, CN 963 A80, CN 964 A85, CN 965 A80, CN 966 A80, CN 981 A75, CN 982 A75, CN 980 M50, CN 961 E75, CN 963 E75, CN 963 E80, CN 964 E75, CN 982 E75, CN 963J85, CN 966J75, CN 966 180, CN 966 R60, and CN 964H90; hexafunctional urethane (meth)acrylates, such as the hexafunctional urethane (meth)acrylates sold by Sartomer Company under the product name CN 975; and urethane (meth)acrylates such as the urethane (meth)acrylates sold by Sartomer Company under the product names CN 972, CN 2901, CN 2902, CN 978, CN 999, CN 970H75, CN 973H85, CN 970 A60, CN 971 A80, CN 973 A80, CN 977 C70, CN 970 E60, CN 973 J75, and CN 1963; and the like; and mixtures comprising at least one of the foregoing acryloyl monomers.

Acryloyl monomers may also be used for crosslinking the primary and secondary binders, the hydrogels, gelling agents, polymeric binders, polymeric additives, impact modifiers, gels, or a combination thereof.

Suitable acryloyl monomers include, for example, methyl (meth)acrylate, ethyl (meth)acrylate, isopropyl (meth)acrylate, n-butyl (meth)acrylate, isobutyl (meth) acrylate, 2-ethylhexyl (meth)acrylate, 2-hydroxyethyl (meth)acrylate, 3-hydroxypropyl (meth)acrylate, hydroxybutyl (meth)acrylate, glycidyl (meth)acrylate, 2,2-dimethyl-3-hydroxypropyl-2,2-dimethyl-3-hydroxypropenoate, isobornyl (meth)acrylate, tetrahydrofurfuryl (meth)acrylate, 3,4-epoxycyclohexylmethyl (meth)acrylate, and the like; halogenated (meth)acrylates such as pentabromobenzyl (meth)acrylate, and the like; and acrylic or methacrylic amides such (meth)acrylamide, diacetone (meth) acrylamide, N(2-hydroxyethyl) (meth)acrylamide, N-methyl(meth)acrylamide, N-ethyl (meth)acrylamide, N,N-dimethyl(meth)acrylamide, N,N-dimethylaminopropyl(meth) acrylamide, N,N-dimethylaminopropyl(meth)acrylamide, N,N-dimethylaminoethyl (meth)acrylamide, and the like; and mixtures comprising at least one of the foregoing acryloyl monomers. It will be understood that the suffix (meth)acryl- denotes either acryl- or methacryl-.

Suitable acryloyl monomers may further include vinyl functionalized anhydrides such as maleic anhydride; and epoxy acrylates, such as the Epoxy Acrylate sold by Sartomer Company under the trade names CN 120 AC16 and CN 118, Epoxidized Soy Bean Oil Acrylate CN 111, Epoxy Acrylate CN 104, Epoxy Acrylate CN 120, Low Viscosity Epoxy Acrylate CN 121, Epoxy Acrylate CN 124, Modified Epoxy Acrylate CN 136, Modified Epoxy Acrylate CN 115, Modified Epoxy Acrylate CN 116, Modified Epoxy Acrylate CN 117, Modified Epoxy Acrylate CN 119, Amine Modified Epoxy Acrylate CN 2100, Fatty Acid Modified Epoxy Acrylate CN 2101, Epoxy Acrylate CN 104 B80, Epoxy Acrylate CN 120 B60, Epoxy Acrylate CN 120 B80, Epoxy Acrylate CN 120 M50, Epoxy Acrylate CN 104 A80, Epoxy Acrylate CN 120 A60, Epoxy Acrylate CN 120 A75, Epoxy Acrylate CN 120 C60, Epoxy Acrylate CN 120 C80, Epoxy Acrylate CN 120 ESO, Epoxy Acrylate CN 120 D80, Epoxy Acrylate with Styrene CN 120 S80, Epoxy Novolac Acrylate CN 112 C60, Epoxy Methacrylate CN 151, and the like.

Suitable acryloyl monomer may further include low viscosity oligomers, such as the low viscosity oligomers sold by Sartomer Company under the product numbers CN 130, CN 131, CN 135, and CN 137; polyester acrylate oligomers, such as the polyester acrylate oligomers sold by Sartomer Company under the product names Polyester Acrylate CN 293, CN 292, and CN 2200, and Chlorinated Polyester Acrylate CN 2201; adhesion promoting oligomers, such as the adhesion promoting oligomers sold by Sartomer Company under the product number CN 704; polybutadiene dimethacrylates, such as the polybutadiene dimethacrylates sold by Sartomer Company under the product numbers CN 301 and CN 303; Polybutadiene Urethane Diacrylate CN 302, and Polybutadiene Dimethacrylate CN 303; specialty oligomers, such as the specialty oligomers sold by Sartomer Company under the tradename SARBOX® as, for example, Aromatic Acid Methacrylate Half Ester in EEP Ester Solvent SB 401, SB 404, and SB 405, Aromatic Acid Methacrylate Half Ester in PM, Alcohol/EEP Ester Solvent SB 402, Aromatic Acid Methacrylate Half Ester in PM, Alcohol Solvent SB 400, Aromatic Acid Acrylate Half Ester in SR 339 SB 520 M35, Aromatic Acid Acrylate Half Ester in SR454 SB 520 E35, Aromatic Acid Methacrylate Half Ester in SR306 SB 520 A20, Aromatic Acid Methacrylate Half Ester in SR344 SB 500 K60, Aromatic Acid Methacrylate Half Ester in SR454 SB 500 E50, and Aromatic Acid Methacrylate Half Ester in SR454 SB 510 E35; acrylates, including, Low Viscosity Triacrylate Oligomer CN 132, Low Viscosity Triacrylate Oligomer CN 133, Low Viscosity Monoacrylate Oligomer CN 152, Urethane Acrylate CN 959, Polyester Acrylate CN 293, Urethane Acrylate CN 968, Urethane Acrylate CN 2901, Urethane Acrylate CN 2902, Urethane Acrylate CN 999, Low Viscosity Aliphatic Monoacrylate CN 135, Low Viscosity Aliphatic Monoacrylate CN 137, Amine Modified Epoxy Acrylate CN 2100, Fatty Acid Modified Epoxy Acylate CN 2101, Polyester Acrylate CN 2200, Chlorinated Polyester Acrylate CN 2201, Acrylated Acrylic CN 2800, Epoxy Acrylate CN 120 ACI 6, Polybutadiene Urethane Diacrylate CN 302, Polybutadiene Dimethacrylate CN 303, (Meth)Acrylate Functional Monomer P-Cure 300, and (Meth)Acrylate Functional Monomer P-Cure 301; functional acrylic oligomers, such as the functional acrylic oligomers sold by Sartomer Company under the tradename SARCRYL® as SARCRYL® Functional AcrylicSarcryl CN816, SARCRYL® Functional AcrylicSarcryl CN817, SARCRYL® Functional AcrylicSarcryl CN818, Amine Modified Polyether Acrylate CN 501, Amine Modified Polyether Acrylate CN 502, Amine Modified Polyether Acrylate CN 550, Amine Modified Polyether Acrylate CN 551, Alkoxylated Trifunctional Acrylate Ester such as SR 9008 sold by Sartomer Co., Metallic Diacrylate SR 9016, and metallic diacrylates such as zinc diacrylate, lithium diacrylate, sodium diacrylate, magnesium diacrylate, calcium diacrylate, aluminum diacrylate, Monofunctional Acid Ester CD 9050, Trifunctional Acid Ester CD 9051 and CD 9052, Trifunctional Acrylate Ester SR 9012, and Trifunctional Methacrylate Ester SR 9009 and SR 9011; and the like; and mixtures comprising at least one of the foregoing acryloyl monomers.

Highly preferred acryloyl monomers include trimethylolpropane tri(meth)acrylate, 1,6-hexanediol di(meth)acrylate, ethylene glycol di(meth)acrylate, propylene glycol di (meth)acrylate, cyclohexanedimethanol di(meth)acrylate, butanedioldi(meth)acrylate, diethylene glycol di(meth)acrylate, triethylene glycol di(meth)acrylate, isobornyl(meth) acrylate, cyclohexyl (meth)acrylate, butyl(meth)acrylate, methyl (meth)acrylate, dibutyl fumarate, dibutyl maleate, glycidyl (meth)acrylate, ethyl (meth)acrylate, 2-ethylhexyl (meth)acrylate, hexyl (meth)acrylate, lauryl (meth)acrylate, stearyl (meth)acrylate, decyl (meth)acrylate, octyl (meth)acrylate, and the like, and mixtures comprising at least one of the foregoing acryloyl monomers.

Another crosslinking agent that may be used includes isocyanates that may react with the hydroxyl groups on the primary and secondary binders, the hydrogels, gelling agents, polymeric binders, polymeric additives, impact modifiers, gels, or a combination thereof. Suitable isocyanates are di-, tri-, or polyisocyanates, that may react with hydroxyl groups on the binders, gelling agents, hydrogels, and the like to form polyurethanes. Examples of diisocyanates include, for example, 4,4′-methylene diphenyl diisocyanate, 2,2′-dimethyl-4,4′-biphenyldiisocyanate, 3,3′-dimethyl-4,4′-diphenyl diisocyanate, methylene diisocyanate, m-phenylene diisocyanate, p-phenylene diisocyanate, cyclohexane-1,4-diisocyanates, 1,6-hexamethylene diisocyanate, toluene-2,4-diisocyanate, toluene-2,6-diisocyanate, p-xylylene diisocyanate, m-xylylene diisocyanate, p-tetramethylxylene diisocyanate (1,4-bis(1-isocyanato-1-methylethyl)benzene), m-tetramethylxylene diisocyanate (1,3-bis(1-isocyanato-1-methylethyl)benzene), isophorone diisocyanate (5-isocyanato-1-(isocyanato methyl)-1,3,3-trimethylcyclohexane), bis(4-isocyanatocyclohexyl)methane, naphthalene-1,9-diisocyanate, and combinations thereof. In some embodiments, aliphatic diisocyanates and alicyclic diisocyanates are excluded from the reaction and the polyurethane product, such that the polyurethane does not comprise units derived from aliphatic diisocyanates or alicyclic diisocyanates.

In one manner of manufacturing the bio-concrete, the bio-cement, the second binder, a second liquid and the substrates are blended together to form the bio-concrete. Crosslinkers and/or initiators may be optionally added. The bio-concrete may be molded to form an article of a desired shape. The article includes bricks, cinder blocks, columns, tiles, and so on, can be conducted in a batch process or a mass production process.

During the formation of the article, the second liquid added may reactivate the microorganisms, which can consume some of the binder or nutrients. The microorganism(s) upon reactivation produce the binder (calcium carbonate, reaction products thereof, or the like) to bond the substrates and reinforcing agents into a shapeable solid. The bio-concrete may then be placed in a mold or injected into a mold to form bricks, cinder blocks, columns, tiles, and so on.

In an embodiment, once the bio-concrete has cured, the bacteria no longer produce the binder. The formulator or user, however, can restore the microbiological activity of the building material by adding sufficient moisture and/or physical conditions to promote activity. In this way any surface imperfections formed during casting of the material, for example, into bricks, can be repaired after curing. This allows for reinforcement of the material to achieve the added strength that the cured material possesses. In this way cracks or fissures which have formed can be filled by the existing microorganisms using the existing matrix elements and nutrient medium.

Another embodiment of the disclosure is directed to compositions and structures that do not require formworks (e.g., frameless manufacturing) wherein structures are formed by compressing the dry composition after the addition of water (which functions as an activating agent). Preferred compression devices include hydraulic presses and preferred pressures are 100 psi or greater, 250 psi or greater, 500 psi or greater, 1000 psi or greater, 2000 psi or greater, 3000 psi or greater, 4000 psi or greater, 5000 psi or greater.

Preferred components of the disclosure include all the aforementioned components to form calcium carbonate structures in the form of a sludge or paste. The compaction device compresses the components with added pressure into a form that is maintained and dries without significant alterations of the resulting form. The compressed form can be generated rapidly from a thick slurry or sludge and maintains its shape during calcite formation. Preferably calcite formation is accomplished in vapor chambers (e.g., at greater than ambient pressures) that contain increased vapor pressures or are sprayed or misted, wherein the vapor, mist or spray preferably comprises nutrients or chemical substrates. Preferred forms include blocks, bricks, thin bricks, manufactured or cultured stone, pavers, panels, or any useful structure.

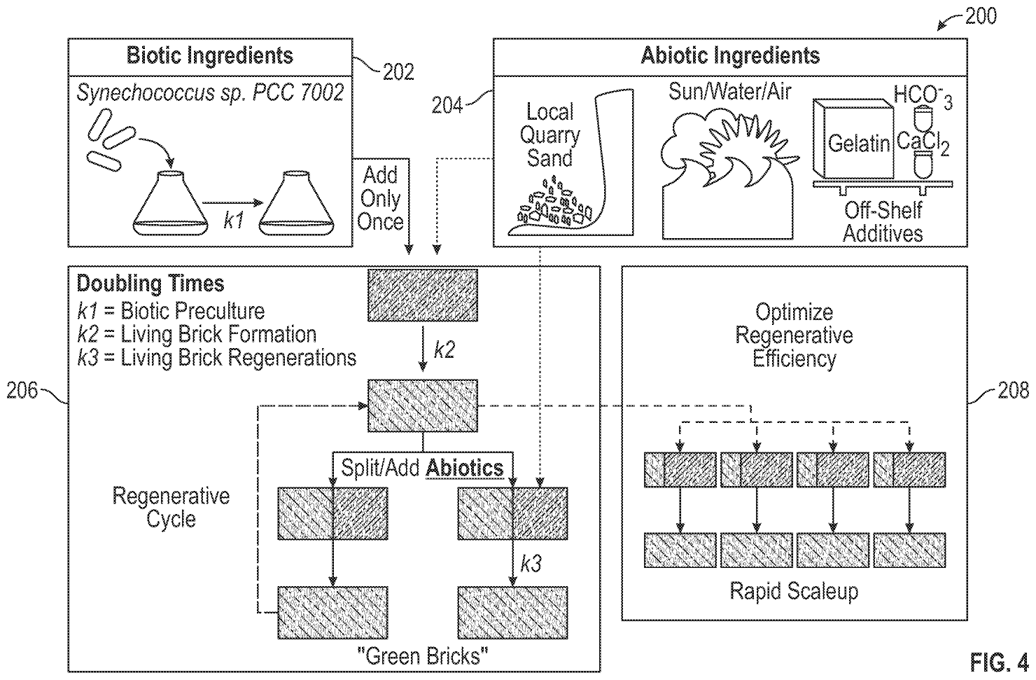

FIG. 4 depicts another method 200 of manufacturing the bio-cement. In this method, in step 202, the microorganisms (or the microorganism package) is/are first mixed with water to activate them. In step 204, the other ingredients such as the binder, the nutrients, additives, and the like, are blended together. In step 206, the activated microorganism package from step 202 is added to the mixture of ingredients from step 204 to form a first dry composition product (a first generation product). In step 206 and 208 portions of the first dry composition product (first generation product) are taken and mixed with several other separate portions of the remaining ingredients of the step 204. This results in multiple simultaneous activations of a plurality of dry compositions to create a plurality of second generation products. All of the compositions are simultaneously activated to form a plurality of bio-cement products as shown in the step 208. The steps detailed above can be repeated by removing a small portion from the plurality of the second generation of bio-cement products and adding them to another plurality of dry compositions to create a third generation of bio-cement products. The number of usable products increases with each generation.

In this manner, a small portion of an activated microorganism package may be continuously added to a plurality of different dry compositions to activate them and to produce large numbers of bio-cement products in a short period of time.

The bio-cement and bio-concrete and the method of manufacturing the bio-concrete are exemplified by the following non-limiting examples.

### Example 1

This example was conducted to demonstrate one exemplary embodiment of a method to manufacture the bio-concrete. The bio-cement is the biomineralized algae (up to 1000 grams present in an amount of 13.5 kilos, with the remainder being the first binder (the calcium carbonate) The procedure for mixing is as follows. The bio-concrete is a 8 inch×6 inch×16 inch (H×W×L) block.
1. Add sand to mixer then add appropriate amount of water for mix design.
2. Blend the sand (the substrate) and water until homogeneous; take sample for moisture analysis.
3. Use moisture analyzer to determine sand moisture; make adjustments as necessary depending on mix design.
4. Add crosslinker solution to sand; mix until homogenous (1-2 minutes).
5. Add the second binder/biomineralized algae powders. Continue mixing.
6. Add fibers. Continue mixing.
7. Add alcohol. Continue mixing. Mixing time is started upon addition of alcohol.
8. Add silica fume. Continue mixing for appropriate time depending on mix design.
9. Use material to cast final product.

The ingredients are shown in the Table 1 below.

TABLE 1

| Ingredient | Amount (g) |
|---|---|
| Sand | 12,600 |
| First binder: biomineralized algae | 50 |
| (algae:calcium carbonate ratio 2:1-1:20) | |
| External second binder: (bio)polymer | 750 |
| Fiber | 50 |
| Alcohol | 729 |
| Total Water | 486 |
| 40% crosslinker solution added to crosslink | 125 |
| the second binder | |
| Silica Fume (densifier - pozzalan-ground | 221 |
| pumice has some cementitious material) | |

*Target for this mix design is A:W = 60:40 and L:B = 1.65.
*Calculations: B = 735.9 g; L = 735.9(1.65) = 1214.24 g; A = 1214.24 (60%) = 728.5 g; Water = 1214.24(40%) = 485.7 g.
*Total water in mix includes water from sand, crosslinker solution, and any additional that may be added depending on mix design.

Ready-mix Formulation Estimate (aggregate sand/rock/1.
1. Part A: Crosslinker solution
2. Part B: Second binder, biomineralized algae, and silica fume.
3. Blend aggregate that has the appropriate amount of moisture for mix design with Part A. Mix for 1-2 minutes.
4. Add Part B and mix for 1-2 minutes.
5. Add alcohol and mix for appropriate amount of time depending on mix design.
6. Use material to cast final product.

Amounts for cubic yard are shown in Table 2.

TABLE 2

| Ingredient | Amount (kg) |
|---|---|
| Aggregate (sand or rock) | 1208.6 |
| Part A: Crosslinker solution | 5.7 |
| Part B: Biopolymer | 70.65 |
| Part B: Biomineralized Algae | 5 |
| Part B: Silica Fume | 21.2 |
| Part B: Fiber (if needed) | 4.6 |
| Total Water | 46.6 |
| Alcohol | 70.0 |

*Part A would be in a separate, smaller package with larger bag for Part A.
*Part B components would all be blended together in a large bag.

What is claimed is:

1. A transportable bio-cement comprising:
a desiccated microorganism package; where the microorganism package comprises:
one or more microorganisms;
a first binder, where the first binder is produced by the microorganism; and where the microorganism has protected itself by a layer of the first binder; where the transportable bio-cement is devoid of moisture.

2. The transportable bio-cement of claim 1, where the bio-cement further comprises a nutrient.

3. The transportable bio-cement of claim 1, where the microorganism is present in the bio-cement in an amount of 0.01 to 25 weight percent based on the total weight of the bio-cement.

4. The transportable bio-cement of claim 1, where the first binder is present in the bio-cement in an amount of 0.01 to 75 weight percent based on the total weight of the bio-cement.

5. The transportable bio-cement of claim 2, where the micro-organism is present in the bio-cement in an amount of 0.01 to 25 weight percent, where the first binder is present in the bio-cement in an amount of 0.01 to 75 weight percent and where the nutrient is present in the bio-cement in an amount of 0.01 to 10 weight percent, based on the total weight of the bio-cement.

6. The transportable dry composition of claim 1, further comprising a reinforcing filler.

7. The transportable dry composition of claim 6, where the reinforcing filler comprises a fiber; and wherein the fibers are carbon fibers, glass fibers, carbon nanotubes, polymeric fibers or a combination thereof.

8. The transportable dry composition of claim 6, where the reinforcing filler comprises a mineral fiber, a plant fiber, a synthetic fiber, or a combination thereof.

9. The transportable dry composition of claim 6, where the reinforcing filler comprises woven and non-woven fibers; wherein the woven and non-woven fibers include glass fiber, glass wool fiber, mineral wool fiber, slag wool fiber, stone wool fiber, basalt fiber, silica fiber, quartz fiber, alumina fiber, steel fiber, silicon carbide fiber, abaca fiber, acrylic fiber, carbon fiber, melamine fiber, cotton fiber, jute fiber, kenaf fiber, bamboo fiber, hemp fiber, linen fiber, flax fiber, or a combination thereof.

10. The transportable dry composition of claim 1, where the microorganism package comprises microorganisms that extract carbon dioxide from the atmosphere.

11. The transportable dry composition of claim 1, where the microorganism package further comprises microorganisms that extract nitrogen from the atmosphere.

12. The transportable dry composition of claim 1, where the microorganism comprises Pseudomonadota, Aquificota, Chlamydiota, Bacteroidota, Chlorobiota, Cyanobacteria, Fibrobacterota, Verrucomicrobiota, Planctomycetota, Spirochaetota, Acidobacteriota, Myxococcaceae, Zymomonas, Escherichia, or a combination thereof.

13. The transportable dry composition of claim 1, where the microorganism comprises Chroococcales, Chroococcidiopsidales, Gloeobacterales, Nostocales, Oscillatoriales, Pleurocapsales, Spirulinales, Synechococcales, Incertae sedis, Gunflintia, Ozarkcollenia, Cyanothece, Synechocystis, or a combination thereof.

14. The transportable dry composition of claim 1, where the microorganism comprises Gloeobacter violaceus PCC 7421, Nostoc sp. PCC 7120, Prochlorococcus marinus MIT 9312, Prochlorococcus marinus MIT 9313, Prochlorococcus marinus NATL2A, Prochlorococcus marinus marinus CCMP 1375, Prochlorococcus marinus pastoris CCMP 1986, Synechococcus elongatus PCC 6301, Synechococcus elongatus PCC 7942, Prochlorococcus sp. CC9311, Prochlorococcus sp. CC9605, Prochlorococcus sp. CC9902, Synechococcus sp. JA-2-3B′a(2-13), Synechococcus sp. JA-3-3Ab, Prochlorococcus sp. WH8102, Synechocystis sp. PCC 6803, Thermosynechococcus elongatus BP-1, Trichodesmium erythraeum IMS101, Prochlorococcus marinus AS9601, Prochlorococcus marinus MIT 9301, Prochlorococcus marinus MIT 9303, Prochlorococcus marinus MIT 9515, Prochlorococcus marinus NATL1A, Synechococcus sp. RCC 307, Prochlorococcus sp. WH 7803, Prochlorococcus marinus MIT 9215, Acaryochloris marina MBIC11017, Prochlorococcus marinus MIT 9211, Cyanothece sp. BH68, ATCC 51142, Microcystis aeruginosa NIES-843, Synechococcus sp. PCC 7002, Nostoc punctiforme PCC 73102, Cyanothece sp. PCC 7424, Cyanothece sp. PCC 7425, Cyanothece sp. PCC 8801, Cyanothece sp. PCC 8802, Cyanobacterium sp. UCYN-A, Anabaena variabilis ATCC 29413, Nostoc azollae 0708, Cyanothece sp. PCC 7822, Arthrospira platensis NIES-39, Synechocystis sp. GT-S, PCC 6803, Mastigocoleus testarum BC008, Crocosphaera watsonii WH 8501, Cyanobacterium stanieri PCC 7202, Geitlerinema sp. PCC 7407, Chroococcidiopsis thermalis PCC 7203, Halothece sp. PCC 7418, Nostoc sp. PCC 7107, Cyanobacterium aponinum PCC 10605, Gloeocapsa sp. PCC 7428, Stanieria cyanosphaera PCC 7437, Leptolyngbya sp. PCC 7376, Oscillatoria nigro-viridis PCC 7112, Calothrix sp. PCC 6303, Anabaena cylindrica PCC 7122, Pseudanabaena sp. PCC 7367, Crinalium epipsammum PCC 9333, Chroococcidiopsis sp. PCC 6712, Calothrix sp. PCC 7507, Planktothrix NIVA-CYA405, Planktothrix NIVA-CYA406, Planktothrix sp. NIVA-CYA407, Microcoleus vaginatus FGP-2, Planktothrix sp. NIVA CYA 15, Planktothrix agardhii NIVA-CYA 34, Planktothrix rubescens NIVA-CYA 98, Anabaena sp. PCC 7108, Spirulina subsalsa PCC 9445, Spirulina major PCC 6313, Synechococcus sp. PCC 7336, Pseudanabaena sp. PCC 6802, Synechococcus sp. KORDI-49 (genome sequencing), Synechococcus sp. KORDI-52 (genome sequencing), Synechococcus sp. KORDI-100 (genome sequencing), Scytonema hofmanni UTEX 2349, Calothrix sp. PCC 7103, Synechococcus sp. WH 8016, Cyanothece sp. BH63E, ATCC 51472, Cyanobium gracile PCC 6307, Synechococcus sp. PCC 7502, Oscillatoria formosa PCC 6407, Oscillatoria acuminata PCC 6304, Synechococcus sp. PCC 6312, Microcoleus sp. PCC 7113, Prochlorothrix hollandica PCC 9006, Oscillatoria sp. PCC 10802, Dactylococcopsis sauna PCC 8305, Pleurocapsa sp. PCC 7327, Pleurocapsa sp. PCC 7319, Cylindrospermum stagnale PCC 7417, Nodosilinea nodulosa PCC 7104, Microchaete sp. PCC 7126, Leptolyngbya boryana PCC 6306, Nostoc sp. PCC 7524, Leptolyngbya sp. PCC 7375, Geminocystis herdmanii PCC 6308, Calothrix desertica PCC 7102, Rivularia sp. PCC 7116, Oscillatoriales sp. JSC-12, Geitlerinema sp. PCC 7105, Chamaesiphon minutus PCC 6605, cyanobacterium PCC 7702, Fischerella sp. PCC 9431, Synechocystis sp. PCC 6803, PCC-N, Synechocystis sp. PCC 6803, GT-I, Fischerella sp. PCC 9605, Fischerella sp. PCC 9339, Synechococcus sp. CC9616, Mastigocladopsis repens PCC 10914, Cyanobacterium sp. ESFC-1, Leptolyngbya sp. PCC 6406, Synechocystis sp. PCC 7509, Synechocystis sp. PCC 6803, PCC-P, Synechocystis sp. PCC 6803, Anabaena sp. 90, Synechocystis ADH, Zymomonas PDC, Escherichia coli-PAL2-FDC1, Escherichia coli HB101/pBU11, Escherichia albertii, Escherichia fergusonii, Escherichia hermannii, Escherichia marmotae[2], Escherichia vulneris, Pseudomonas D2, Pseudomonas F2, Myxococcus xanthus, Myxococcus xanthus DK 1622, Myxococcus xanthus DZ2, Myxococcus xanthus DZF1, Myxococcus xanthus NewJersey2, Myxococcus xanthus DSM16526T, Bacillus sphaericus, Lysinibacillus sphaericus INQCS 414, and S. pasteurii MTCC 1761, or a combination thereof.

15. The transportable dry composition of claim 1, where the microorganisms comprise Sporosarcina pasteurii, Sporosarcina ureae, Proteus vulgaris, Bacillus sphaericus, Myxococcus xanthus, Proteus mirabilis, Helicobacter pylori, or a combination thereof.

16. The transportable dry composition of claim 1, where the microorganisms comprise a green algae; where the green algae comprise Chlorella vulgaris, Ulva lactuca, Caulerpa taxifolia, Nannochloropsis sp., Chlamydomonas reinhardtii, Volvox carteri, Dunaliella salina, Chara sp., Scenedesmus sp., Cladophora sp., and Trebouxia sp., or a combination thereof.

17. The transportable dry composition of claim 1, further comprising a substrate, where the substrate comprises a ceramic, a metal, a polymer or a combination thereof.

18. The transportable dry composition of claim 17, wherein the ceramic substrates comprise at least one of metal oxides, metal carbides, metal nitrides, metal borides, metal silicides, metal oxycarbides, metal oxynitrides, metal boronitrides, metal carbonitrides, metal borocarbides, or a combination thereof.

19. The transportable dry composition of claim 17, wherein the ceramic substrates comprise at least one of sand, silica, fumed silica, alumina, fumed alumina, titania, zirconia, ceria, metal oxide aerogels, or a combination thereof.

20. The transportable dry composition of claim 17, wherein the ceramic substrates comprise at least one of silicon dioxide, aluminum oxide, aluminum silicate, hydrated calcium, hydrated aluminum, titanium dioxide, zirconium dioxide, indium tin oxide, antimony tin oxide, cerium oxide, cadmium-oxide, titanium nitride, silicon nitride, aluminum nitride, titanium carbide, silicon carbide, titanium niobium carbide, stoichiometric silicon boride compounds, or a combination thereof.

21. The transportable dry composition of claim 17, wherein the reinforcing filler includes glass beads, broken glass, recycled tires, impact modifiers, polymeric fibers, carbon black, or a combination thereof.

22. The transportable dry composition of claim 1, further comprising a binder, where the binder is at least one of gelatins, alginates, carrageenans, oligosaccharides, polysaccharides, or a combination thereof.

23. The transportable dry composition of claim 1, further comprising a binder, where the substrate comprises gelling agents; where the gelling agents comprise at least one of vegetable gums, a pectin blend that includes one or more of konjac, xanthan, pectin, locust bean gum and/or agar, gelatin, gellan gum, carrageenan, guar gum, psyllium seed gum, yam starch powder, alginate, seaweed flour, tragacanth gum, karaya gum, curdlan, soy polysaccharides, alginic acid, carboxymethylcellulose, agar-agar, locust bean gum, gelatin, alginate, arabinoxylan, arrowroot, cassia gum, cellulose, gum Arabic, karaya gum, konjac, kuzu, maltodextrin, marshmallow root, pectin, sodium alginate, starch, xanthan zein, gum, b-glucan or a combination thereof.

24. The transportable dry composition of claim 1, where the composition is dried by natural evaporation, spray drying, or freeze drying prior to transportation.

25. A bio-concrete comprising:
a desiccated microorganism package; where the microorganism package comprises:
one or more microorganisms;
a first binder, where the first binder is produced by the microorganism; and where the microorganism has protected itself by a layer of the first binder;
a substrate; where the substrate is operative to act as a site for bonding with the first binder produced by the microorganism; and
an second binder; where the second binder is not produced by a microorganism.

26. The bio-cement of claim 25, where the second binder comprises zein.

27. The bio-cement of claim 25, where the second binder comprises calcium carbonate and zein.

28. A method of manufacturing a transportable dry composition comprising:
blending together a microorganism package; a nutrient; and a liquid;
activating the microorganism package to produce a first binder;
subjecting the microorganism package to desiccation to form a transportable bio-cement; and
blending the transportable bio-cement with an aggregate to form a bio-concrete;
where the aggregate comprises a substrate, a second binder, and a liquid.

29. The method of claim 28, wherein the transportable bio-cement is formed at a first site and where the bio-concrete is formed at a second site different from the first site.

30. The method of claim 28, wherein the bio-concrete is molded to form an article.
